(19) United States
(12) Patent Application Publication
(10) Pub. No.: US 2007/0198428 A1
(43) Pub. Date: Aug. 23, 2007

(54) Purchasing of computer service access licenses

(75) Inventors: Lingan Satkunanathan, Kirkland, WA (US); Murali Vajjiravel, Sammamish, WA (US); Eric B. Watson, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/360,275

(22) Filed: Feb. 22, 2006

(51) Int. Cl. G06Q 99/00

(52) U.S. Cl. 705/59

(57) ABSTRACT

Purchasing of computer licenses for accessing computer services can be integrated, automated, and secured in a variety of ways. License purchasing rules can be created and used to automatically purchase licenses. License purchasing can take place via an online license purchase portal. Purchased licenses can be automatically downloaded and installed. Licenses can be purchased through a licensor, or through a reseller. Purchased licenses can be stored. Purchased licenses can be in a format defined by a schema. A license schema can define fields for identifying and validating the license.

### BACKGROUND

Despite advances in technology, purchasing computer licenses for computer services can be a difficult task. For example, a computer user (e.g., an administrator of a computer network) may not even know when licenses need to be purchased because the licensing system may not provide any mechanism for letting the user know when additional licenses should be purchased. Furthermore, the computer user may not know what licenses have been purchased in the past. While the computer user may want to be compliant with all licensing, the user may not have the resources available to do so without significant effort.

Generally, a computer user obtains licenses from a retailer or reseller. For example, the user can go to a retail computer store and buy a license allowing access to an email service. Such licenses are typically pre-packaged (i.e., they are created prior to the time of purchase and they are not customized specifically for the purchaser), so they may not meet the user's specific needs. Such licenses typically contain limited information. Due to the limited information, such licenses can be difficult to secure and authenticate. When a user obtains a license, the user typically has to manually install the license. This process can be time consuming and prone to errors.

Therefore, there exists ample room for improvement in technologies related to purchasing licenses for accessing computer services.

### SUMMARY

A variety of technologies related to purchasing computer licenses for accessing computer services can be applied. Such technologies can be used for the automated purchasing of licenses (e.g., in an integrated end-to-end license purchasing environment for automating and simplifying the purchasing of licenses for accessing computer services). For example, license purchasing rules can be used to automate the license purchasing process. Licenses can be automatically purchased through an online license purchase portal and automatically downloaded and installed as electronic representations of the license. Various types of license purchasing rules can be used (e.g., pre-installed or user-created rules). To further automate the license purchasing process, license purchasing information (e.g., pre-stored information such as billing information) can be used.

License purchasing can take place through a reseller (e.g., by using a reseller preference). License purchasing can also take place directly through a licensor without any reseller in the process. Purchased licenses (e.g., as an electronic representation of the license) can be stored offsite (e.g., for disaster recovery). Purchased licenses can also be stored at the customer's site. Licenses can be purchased, as an electronic representation of the license, in a format described by a schema defined by a meta language (e.g., XML or XrML). The schema can define various fields describing the license.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram showing an exemplary system for purchasing licenses.

FIG. 2 is a flowchart showing an exemplary method for purchasing licenses.

FIG. 3 is a block diagram illustrating an exemplary customer network.

FIG. 4 is a flowchart showing an exemplary method for evaluating license purchasing rules in order to make a purchasing decision.

FIG. 5 is a flowchart showing an exemplary method for the automated purchasing of licenses using stored information.

FIG. 6 is a flowchart showing an exemplary purchase approval.

FIG. 7 is a flowchart showing an exemplary license alert.

FIG. 8 is a screenshot illustrating an exemplary license alert.

FIG. 9 is a block diagram showing an exemplary system for purchasing licenses using a reseller.

FIG. 10 is a flowchart showing an exemplary method for purchasing a license through a reseller.

FIG. 11 is a block diagram showing an exemplary system for purchasing licenses through a licensor.

FIG. 12 is a flowchart showing an exemplary method for purchasing a license through a licensor.

FIG. 13 is a flowchart showing an exemplary method for storing a purchased license.

FIG. 14 is a block diagram showing an exemplary computer network supporting various aspects of licensing.

FIG. 15 is a flowchart showing an exemplary receipt of a license.

FIG. 16 is a flowchart showing an exemplary method of installing a license using an XML schema.

FIG. 17 is a diagram illustrating an example of an XML license schema.

FIG. 18 is a block diagram showing an exemplary system for purchasing and activating a dynamic license pack.

FIG. 19 is a flowchart showing an exemplary method for purchasing and activating a dynamic license pack.

FIG. 20 is a flowchart showing an exemplary method for activating a dynamic license pack.

FIG. 21 is a block diagram showing an exemplary license purchasing environment.

FIG. 22 is a block diagram showing an exemplary computer network supporting license provisioning and enforcement.

FIG. 23 is a flowchart showing an exemplary method of creating a license provisioning rule.

FIG. 24 is a flowchart showing an exemplary method for an automated license assignment.

FIG. 25 is a diagram illustrating explicit license assignments.

FIG. 26 is a flowchart showing an exemplary method for an automated service assignment.

FIG. 27 is a diagram illustrating service assignments.

FIG. 28 is a block diagram showing an exemplary realm.

FIG. 29 is a flowchart showing an exemplary method for enforcing licensing.

FIG. 30 is a flowchart showing an exemplary method for enforcing licensing in a multi-server environment.

FIG. 31 is a flowchart showing an exemplary method for warning of licensing problems.

FIG. 32 is a flowchart showing an exemplary method for enforcing license requirements to connect to services using license assignments.

FIG. 33 is a flowchart showing an exemplary method for enforcing license requirements to connect to services using service assignments.

FIG. 34 is a block diagram showing an exemplary system for authenticating promotions.

FIG. 35 is a flowchart showing an exemplary method for authenticating promotions.

FIG. 36 is a block diagram illustrating an example of a computing environment that can be used to implement any of the technologies described herein.

FIG. 37 is block diagram illustrating an example of a computer system that can be used to implement any of the technologies described herein.

### DETAILED DESCRIPTION OF EXEMPLARY EMBODIMENTS

### EXAMPLE 1

### Exemplary License

In any of the examples described herein, a license can comprise the right (e.g., permission) to use computer software according to one or more license terms. The right to use computer software can comprise the right to run (e.g., execute) computer software, or the right to access computer services. The right to use computer software can comprise the right to use computer software on a local computer network (e.g., the network of a business or organization) or on a remote computer network (e.g., the Internet). For example, a license can comprise the right to access hosted services (e.g., external storage services, collaboration services) on the Internet.

A license can also comprise a group of licenses (e.g., a group of related licenses comprising the right to access or use a group of related software programs or services).

A license comprising the right to access a computer service can be represented by an electronic representation (an electronic representation of a license). For example, an electronic representation of a license can be used when purchasing, downloading, installing (e.g., storing), managing, or enforcing the license. For example, the information within an electronic representation of a license can be used when determining whether to allow access to a computer service.

Such an electronic representation can include security measures (e.g., digital signatures, digital certificates, and the like). The electronic representation can include information identifying the licensee (e.g., the name of the licensee) to prevent unauthorized transfer or copying to another party.

As described herein, access to a service can be denied if there is no adequate license (e.g., stored as an electronic representation of the license).

### EXAMPLE 2

### Exemplary License Purchasing System

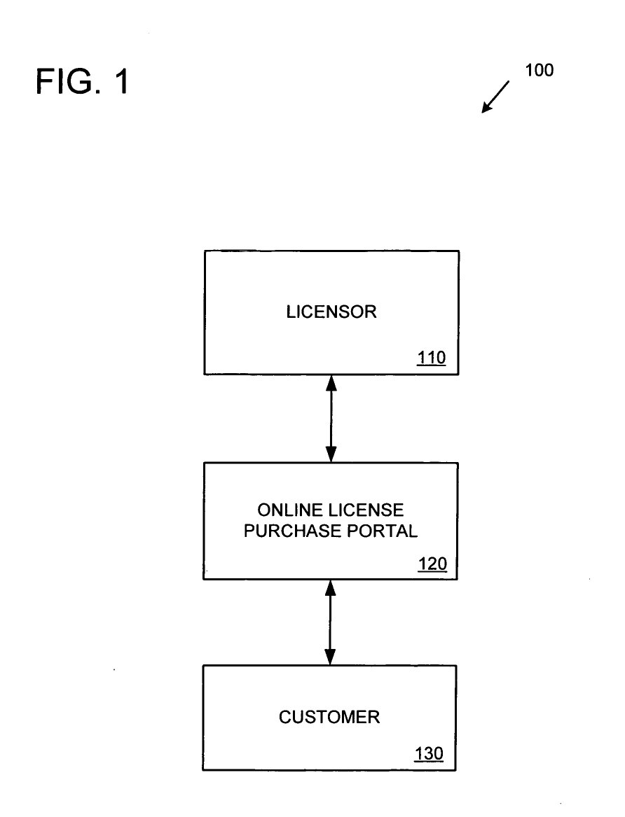

FIG. 1 shows an exemplary system 100 for purchasing licenses comprising a licensor 110, an online license purchase portal 120, and a customer 130. In the example, the customer 130 communicates with the online license purchase portal 120 in order to purchase a license. The online license purchase portal 120 communicates with the licensor 110 in order to obtain the license.

### EXAMPLE 3

### Exemplary License Purchasing Method

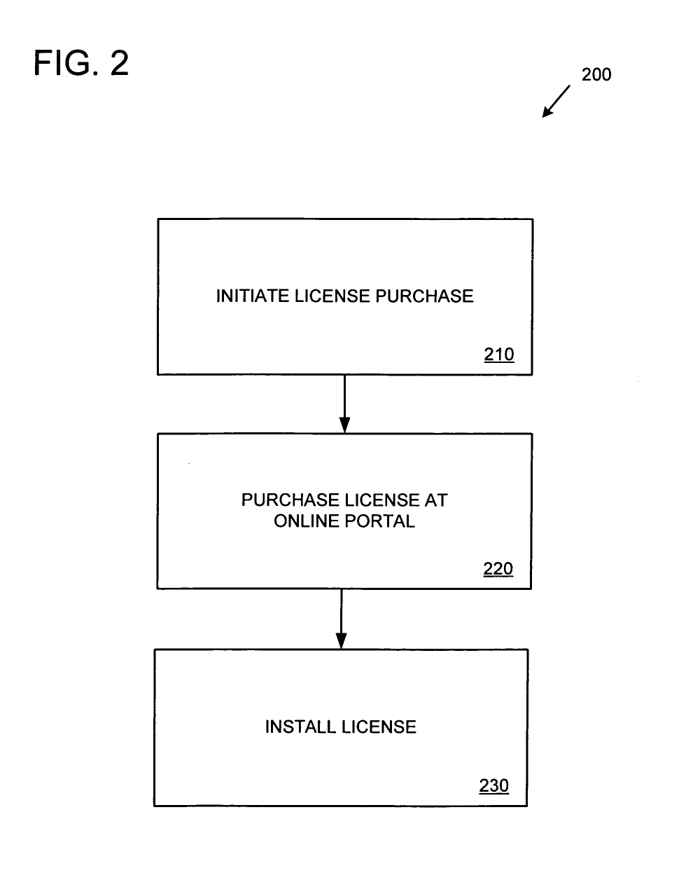

FIG. 2 shows an exemplary method 200 for purchasing licenses and can be performed, for example, by a system such as that shown in FIG. 1. At 210, the license purchase is initiated (e.g., by a customer or rule). At 220, the license is purchased at an online portal (e.g., an online license purchasing portal). Finally, at 230, the electronic representation of the license is installed. For example, installation of a license can comprise various tasks, including: assigning, parsing, extracting, authenticating, and storing. A license that is purchased using this method can result in automatic download and installation of an electronic representation of the license. For example, the electronic representation of the license can be automatically downloaded and installed on a server on the customer's network without the customer's interaction.

The method 200 for purchasing licenses can be performed from a device (e.g., a computer server) that will access the software or service that is being licensed. It can also be performed from a different device (e.g., a different computer server or a user's desktop computer) by downloading the license to the different device and later installing the license on the device that will access the software or service that is being licensed.

Furthermore, the entire license purchasing method can be automated. For example, the method may be performed automatically in response to evaluating a license purchasing rule without any involvement by the customer. Or, the customer may have some involvement in the automated method. For example, the customer may be requested to authorize a license purchase.

The license purchasing method can also be entirely or partially manual in operation (e.g., require customer interaction). For example, a customer can manually connect to an online portal, manually enter license purchasing information to purchase a license, and manually download and install the purchased license.

### EXAMPLE 4

### Exemplary Customer

In any of the examples described herein, a customer can be a purchaser of licenses. For example, a customer can be an individual computer owner, a business, or an organization. Typically, in the case of a business or organization, one or more individual computer users purchase licenses on behalf of the business or organization.

### EXAMPLE 5

### Exemplary Customer Network

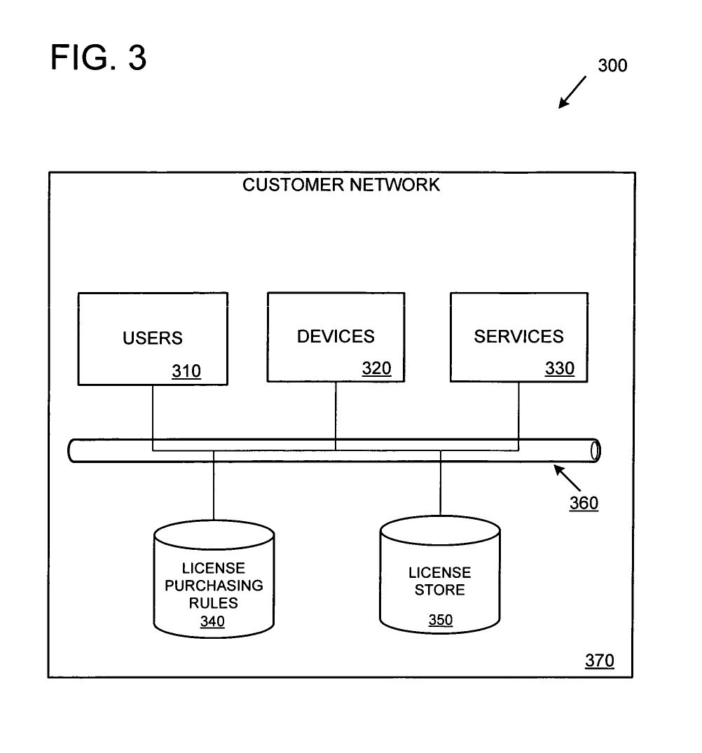

FIG. 3 shows an exemplary customer network 300. The customer network is a computer network. In the example, various items can be associated with the customer network.

Users 310 can be associated with the customer network. For example, users can be people who use the customer network (e.g., typical employee, IT administrator, purchasing manager) via a username or other authentication method.

Devices 320 can also be associated with the computer network. For example, devices can be computers (e.g., an employee's desktop or laptop computer), servers (e.g., file servers, application servers), or any other type of device (e.g., firewall or gateway device, printer, copier, scanner, communications device).

Services 330 can be associated with the customer network. For example, services can be services provided by computer software (e.g., email services, accounting system services, virus scanning services, spam filtering services, backup services, and the like). Services can be provided by software running on servers or other devices on the customer network.

The customer network can have a storage facility for license purchasing rules 340. The license purchasing rules can control the purchasing of licenses for the customer network. The license purchasing rules can also be automated so that they are checked automatically without user intervention (e.g., automatically checked periodically).

The customer network can have a license store 350. The license store can store electronic representations of licenses for the customer network. For example, the electronic representations of licenses can be assigned to users 310 or devices 320 and be required to access one or more of the services 330 on the customer network 300. The license store can be under the control of a customer operating the customer network.

The items in the customer network 300 can be linked together via a network 360. For example, the network 360 can be physical network cabling, a wireless network, or some combination thereof. Various items can be linked together via various network hardware, protocols, and topologies. For example, the network 360 can be a local area network, a wide area network, or a distributed network.

### EXAMPLE 6

### Exemplary License Purchasing Rules

In any of the examples described herein, license purchasing rules can control the purchasing of licenses. One type of license purchasing rule is a pre-installed license purchasing rule. A pre-installed license purchasing rule is a purchasing rule that can be created by a manufacturer or seller of software, but not by the end-user (i.e., customer) of the software. An example of a pre-installed license purchasing rule is a rule that initiates a license purchasing process when a new user is added to a computer network when there are no more licenses available for that new user. This type of license purchasing rule can also be a user-created license purchasing rule.

Another type of license purchasing rule is a user-created license purchasing rule. A user-created license purchasing rule is a purchasing rule that can be created by a user associated with a customer (e.g., an IT administrator of a customer business). An example of a user-created license purchasing rule is a rule that initiates a license purchasing process for a configurable number of (e.g., five) additional licenses when the number of remaining free licenses for access to a specific service drops below a configurable threshold (e.g., three). This type of license purchasing rule can also be a pre-installed license purchasing rule. Values can be configured by the user, manufacturer, or seller.

A license purchasing rule can also operate to limit the number or frequency of license purchases. For example, a license purchasing rule can limit the number of licenses that are automatically purchased (e.g., limit of 10 licenses purchased automatically over a two month period).

### EXAMPLE 7

### Exemplary Evaluating License Purchasing Rules

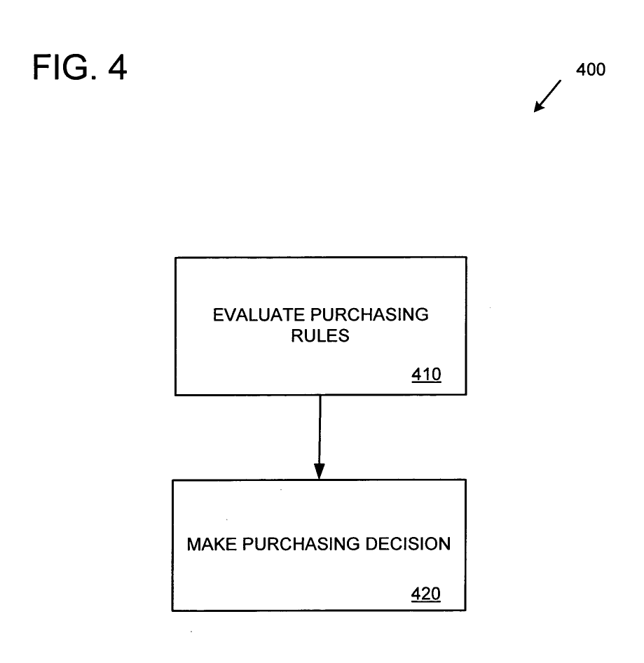

FIG. 4 shows an exemplary method 400 for evaluating license purchasing rules 410 and making a purchasing decision 420. For example, a license purchasing rule can display an alert to a user indicating that there are no more licenses of a specific type available. Based on the alert, the user can make a purchasing decision (e.g., a decision to purchase another license). Or, license purchasing rules can be evaluated by software to automatically make a license purchase.

For example, a user (e.g., an IT administrator) can receive an alert (e.g., a pop-up window), based on a license purchasing rule, while adding a new user or device stating that there are no more licenses available. The user can click on a button within the alert to automatically and immediately purchase and install the license needed for the new user or device.

### EXAMPLE 8

### Exemplary License Purchasing Information

In any of the examples described herein, license purchasing information can include, for example, customer name and address, credit card information, and other information that can be used to purchase a license (e.g., information that can be used to obtain payment of an invoice). License purchasing information can be stored before a license purchase is made and retrieved and used automatically during the license purchase. The license purchasing information could be stored in a number of locations. For example, the information can be stored at the customer's site (e.g., in a database on the customer's computer). In some cases, the information can be stored somewhere other than the customer's site, such as at an online license purchase portal or a licensor. License purchasing information can also be transmitted (e.g., via a network) to a license purchasing site (e.g., an online license purchase portal).

### EXAMPLE 9

### Exemplary Automated License Purchasing Method using Stored Information

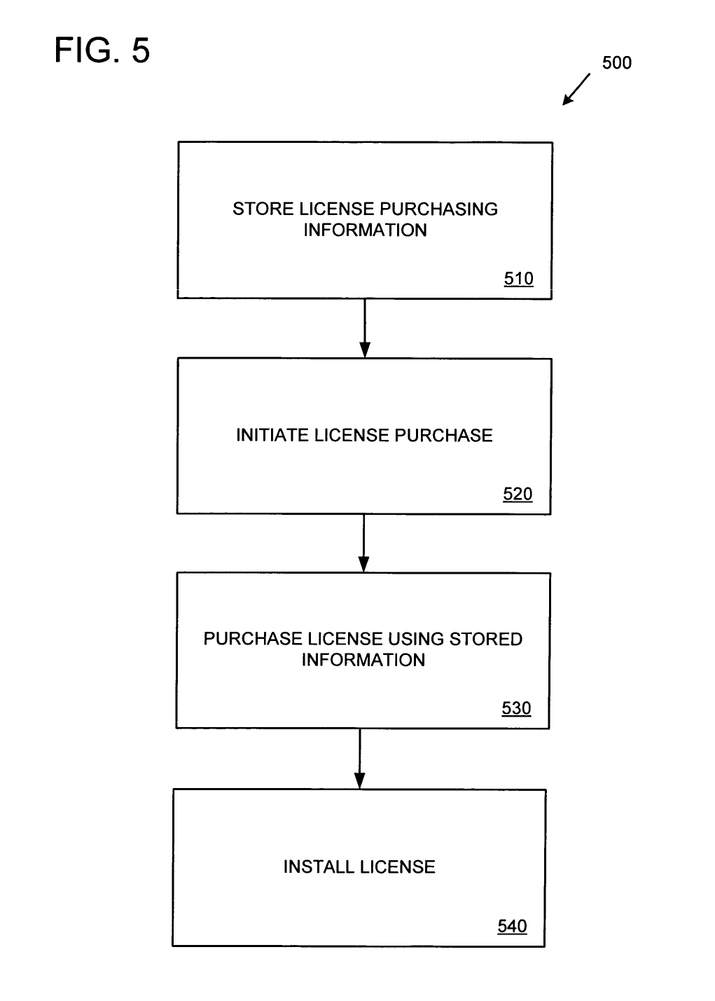

FIG. 5 shows an exemplary method 500 for the automated purchasing of licenses using stored information. At 510, license purchasing information is stored. At 520, the license purchase is initiated. At 530, the license is purchased using the stored license purchasing information. This purchase can take place at an online portal (e.g., an online license purchasing portal). Finally, at 540, the electronic representation of the license is installed.

This license purchasing method can be automated. Because the license purchasing information is stored prior to the initiation of the license purchase, the license purchase can take place without any interaction by the customer. For example, a license can be automatically purchased from an online license purchasing portal in response to the need for an additional license by the customer, without the customer having to authorize, initiate, or participate in the purchase (e.g., responsive to determining the number of remaining licenses has fallen below a configurable threshold). Alternatively, the customer could be involved in the purchase process. For example, the customer could be presented with an alert stating that a new license is needed and if the customer indicates approval the license can be purchased using stored license purchasing information without any further involvement by the customer. Or, the customer could have some further involvement, such as involvement with: initiating the purchase, entering purchasing information in addition to the stored license purchasing information, or installing the license.

### EXAMPLE 10

### Exemplary Purchase Approval

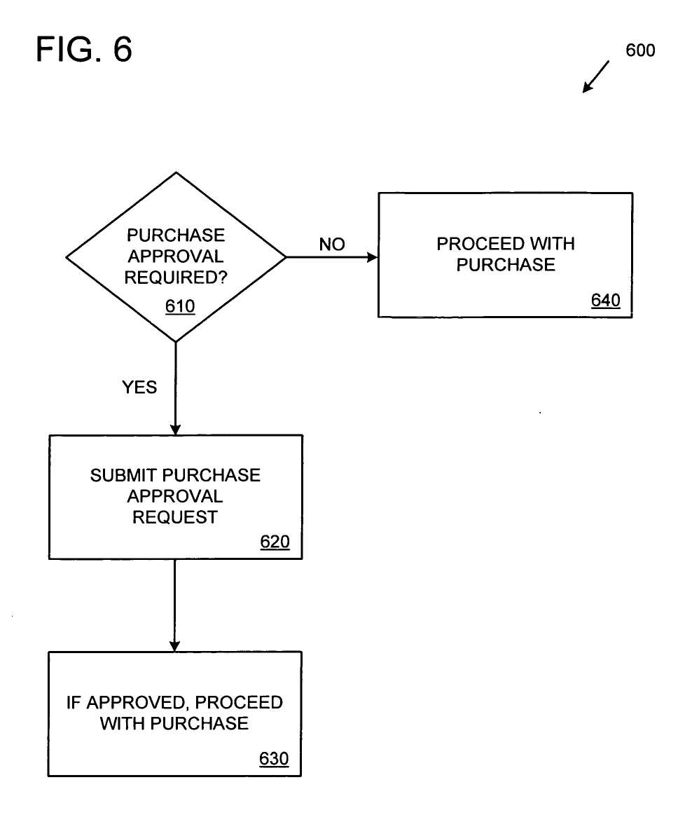

FIG. 6 shows an exemplary method 600 for the approval of a license purchase request. At 610 a decision is made as to whether a purchase approval is required for the purchase. In some cases, a purchase approval may not be required for the purchase. For example, the customer may have created a rule allowing the purchase of a license without first providing authorization. Such a rule could also include restrictions such as a limit to the number of licenses that can be purchased using the rule (e.g., limit of 10 licenses per month). If a purchase approval is not required, then the purchase can proceed 640.

In other cases, a purchase approval by a user may be required. If a purchase approval is required, a purchase approval request is submitted 620. If the purchase approval request is approved, then the purchase can proceed 630. A purchase approval request can take a variety of forms. For example, a purchase approval request can be an alert window displayed on a computer where the user of the computer could indicate approval by clicking on a button in the alert window. A purchase approval request can comprise sending an electronic purchase order for approval (e.g., by the purchasing department of a customer business).

### EXAMPLE 11

### Exemplary License Alert

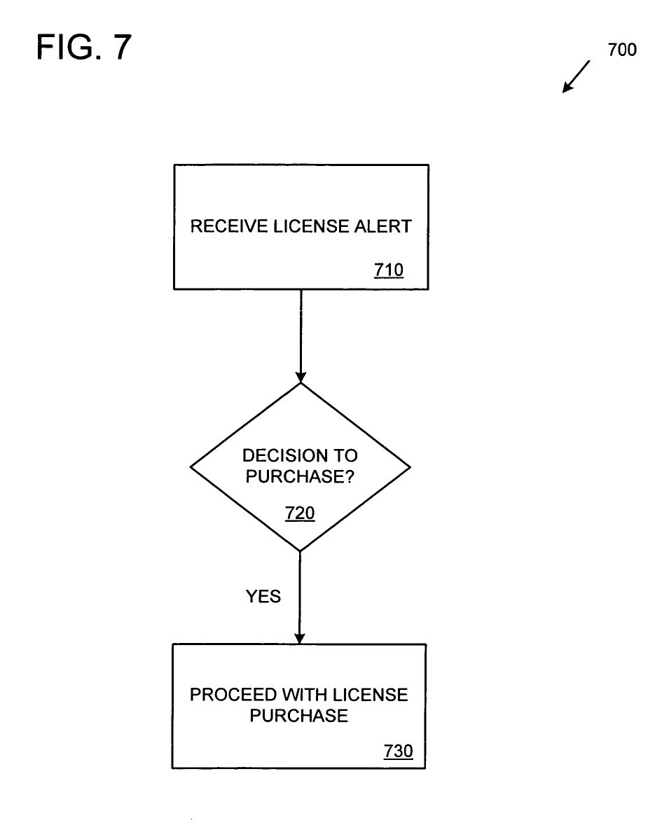

FIG. 7 shows an exemplary license alert method 700. At 710, a license alert is received. A user can configure how the alert is to be sent. For example, the license alert may be received by a user as a pop-up window on the user's computer. The license alert may also be received, for example, in an email message. At 720, a decision of whether or not to purchase a license is made. For example, the license alert may include a button in a pop-up window for purchasing a license. At 730, if the decision to purchase is made, the license purchase proceeds.

### EXAMPLE 12

### Exemplary License Alert Screenshot

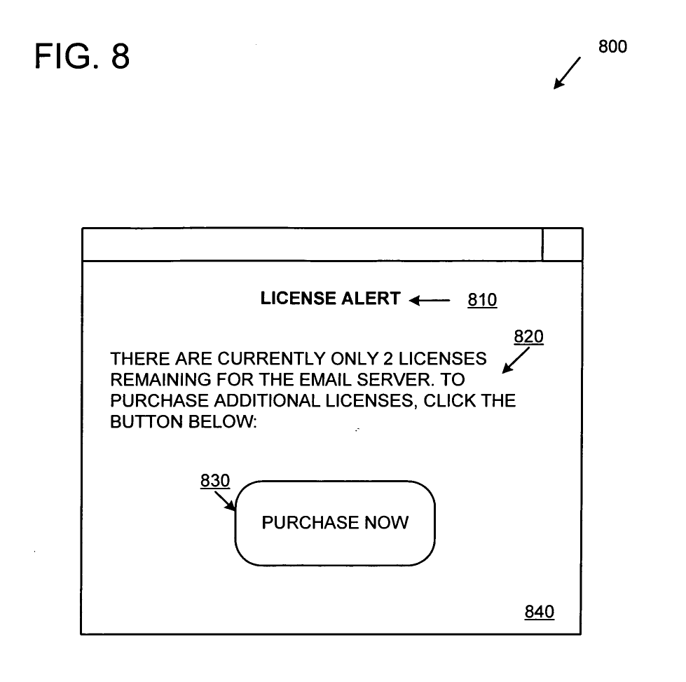

FIG. 8 shows a screenshot 800 illustrating an exemplary license alert 840. For example, the license alert can be in the form of a window displayed on a computer. The license alert can have a title 810. The license alert can also have an alert message 820. The license alert message can describe a licensing problem. For example, the license alert message can warn that there are only a certain number of licenses remaining and that additional licenses should be purchased (e.g., as indicated by a rule). The license alert can also warn that a license limit has been exceeded (e.g., that there are more users connected to a service than there are licenses available). In this way, the license alert can be proactive in warning of a likely need for additional licenses in the future, or it can be reactive in warning of a current licensing problem. For example, a reactive license alert can warn that a user cannot be licensed to use an email service (e.g., in response to adding the user) because there are no more licenses available.

Additional licenses can be purchased by clicking on a purchase button 830. For example, an IT administrator can receive the license alert and decide to purchase additional licenses by clicking on the purchase button. The license alert can be part of an automated license purchase in which licenses are automatically purchased and installed when the purchase button is clicked. Additional buttons can also be included in the license alert, such as a button indicating a decision not to make a license purchase.

### EXAMPLE 13

### Exemplary Licensor

In any of the examples described herein, a licensor can be an entity that licenses any type of software or access to software (e.g., software products, services running on software). For example, a licensor can be a software developer that sells software and licenses allowing access to services operated by the software. A licensor can also be a software manufacturer, vendor, owner, or any other entity that licenses software.

### EXAMPLE 14

### Exemplary License Purchase Portal

In any of the examples described herein, a license purchase portal is a virtual location from which licenses can be purchased. For example, a license purchase portal can be an online license purchase portal (e.g., a web site on the Internet). A license purchase portal can be operated by a licensor or by a third party. A license purchase portal can be located at a licensor (e.g., a web site located on a network operated or controlled by the licensor), or at another location.

For example, a licensor can have a single license purchase portal, or multiple purchase portals. A licensor can chose to have (e.g., operate) a single license purchase portal in order to ensure quality and a consistent purchasing experience.

### EXAMPLE 15

### Exemplary Reseller

In any of the examples described herein, a reseller is a reseller of licenses. A reseller is an entity, not the licensor, which sells licenses. A reseller can have a business relationship with the licensor for selling the licensor's licenses (e.g., a reseller channel). A reseller can sell licenses to customers.

### EXAMPLE 16

### Exemplary Reseller Preference

In any of the examples described herein, a reseller preference can be associated with a customer. The reseller preference identifies a specific reseller. The reseller preference can be created by a reseller that sells software (or hardware on which the software is installed) to the customer, or installs or configures software for the customer. For example, a reseller may sell a customer a software package and include a reseller preference in the software package that identifies the reseller. It is also possible for the customer to create a reseller preference or change an existing reseller preference. For example, a reseller preference may have been created at the time of software purchase or installation, but the customer may want to change it to a different reseller at a later time.

The reseller preference can be used when making a license purchase. The reseller preference can be used to purchase a license through the specific reseller identified by the reseller preference (e.g., purchased directly from the reseller, or via a purchase portal).

For example, a customer can connect directly to a license reseller site (e.g., web site or web service) identified by a reseller preference. The reseller can then purchase the license through a license purchase portal and deliver the purchased license to the customer.

The reseller preference can also be transmitted to a license purchase portal in order to identify a specific reseller through which to make a license purchase. For example, the license purchase portal can receive the reseller preference and credit the reseller identified by the reseller preference with license purchases made using the reseller preference. The license purchase portal can also redirect license orders to the reseller's site (e.g., located on the license purchase portal, at web site or web service of the reseller, or elsewhere) identified by the reseller preference.

In order for a reseller to participate in selling licenses using a reseller preference, a reseller can be required to create a reseller account with a license purchase portal (e.g., by registering).

The reseller preference can be used to customize the customer experience. For example, reseller logos or branding can be presented when purchasing licenses (e.g., in the alert 840 of FIG. 8).

### EXAMPLE 17

### Exemplary License Storage Account

In any of the examples described herein, a license storage account can be used to store electronic representations of licenses purchased by a customer from a licensor or reseller, and is associated with the customer. A license storage account can also be used to track purchasing activity, and to store other information (e.g., purchased software products). A license storage account can be operated by a licensor or by another entity. A license storage account is stored offsite from the customer. Because the license storage account is offsite, it can be used by the customer for disaster recovery. For example, if the customer's computer network is destroyed (e.g., by a hurricane), and all license information in possession of the customer is lost, the customer can access the license storage account to retrieve and reinstall the licenses (e.g., by retrieving and reinstalling the electronic representations of the licenses) stored therein.

For example, when a customer makes a purchase from a license purchase portal, a copy of the electronic representation of the purchased license can be stored in a license storage account. The customer can be given access to the license storage account to view or access the contents.

### EXAMPLE 18

### Exemplary License Purchasing System using a Reseller

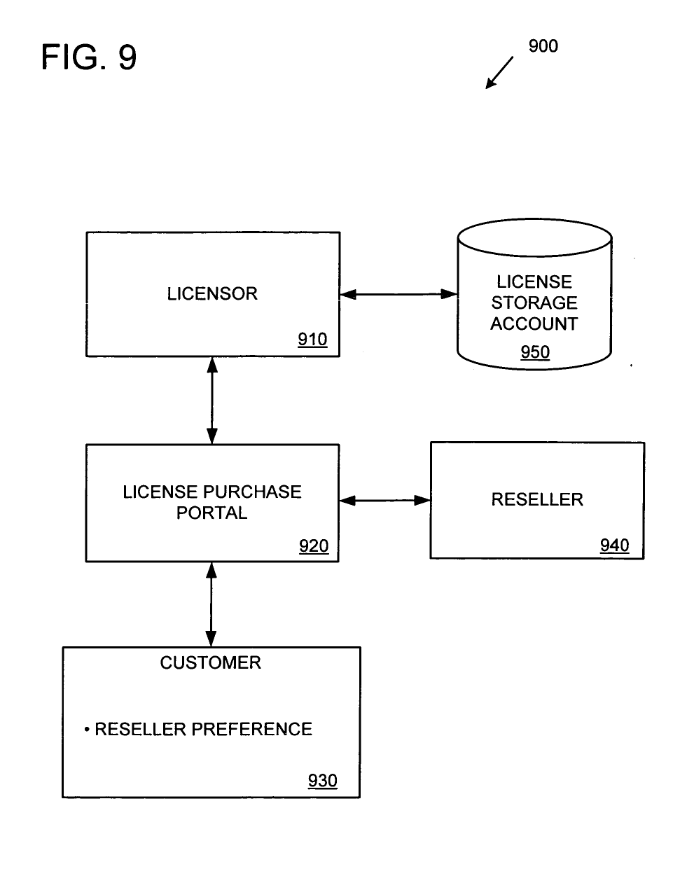

FIG. 9 shows an exemplary system 900 for purchasing licenses using a reseller. In the example, a customer 930 can purchase a license from a license purchase portal 920. The customer can purchase the license through the license purchase portal using a specific reseller 940 identified by a reseller preference of the customer 930. The license is provided by a licensor 910. The purchased license can be stored (as an electronic representation of the license) in a license storage account 950.

### EXAMPLE 19

### Exemplary Purchasing License through a Reseller

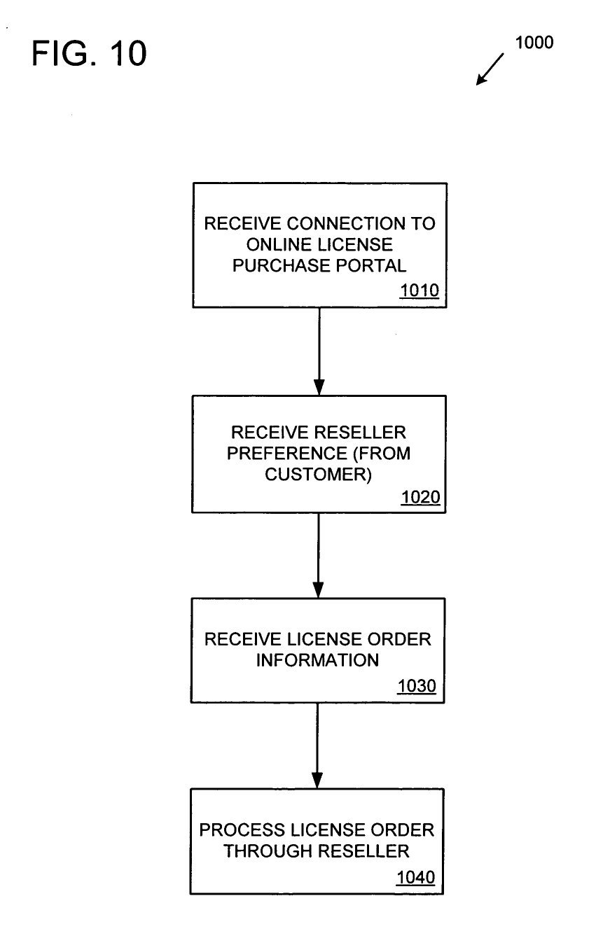

FIG. 10 shows an exemplary method 1000 for purchasing a license through a reseller. The method can be performed, for example, by a system such as that shown in FIG. 9. At 1010, a connection to an online license purchase portal is received. For example, the online license purchase portal can be a web site on the Internet. At 1020, a reseller preference is received from the customer purchasing the license. The reseller preference identifies a specific reseller through which the license is to be purchased. At 1030, license order information is received from the customer. At 1040, the license order is processed through the reseller (e.g., through a license purchase portal or through a web site or web service of the reseller).

### EXAMPLE 20

### Exemplary License Purchasing System through a Licensor

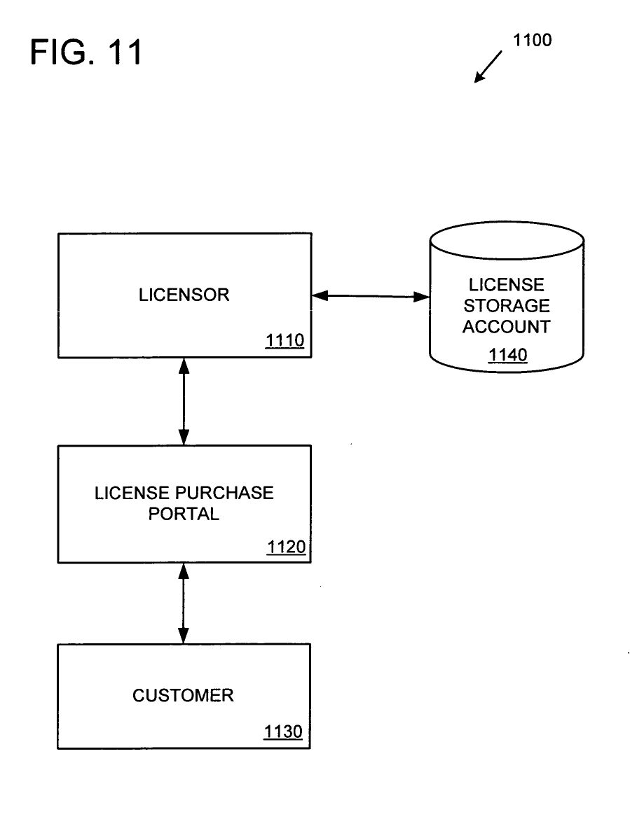

FIG. 11 shows an exemplary system 1 100 for purchasing licenses through a licensor. In the example, a customer 1130 can purchase a license through a licensor 1110 using a license purchase portal 1120. The purchased license can be stored (as an electronic representation of the license) in a license storage account 1140.

### EXAMPLE 21

### Exemplary Purchasing License through a Licensor

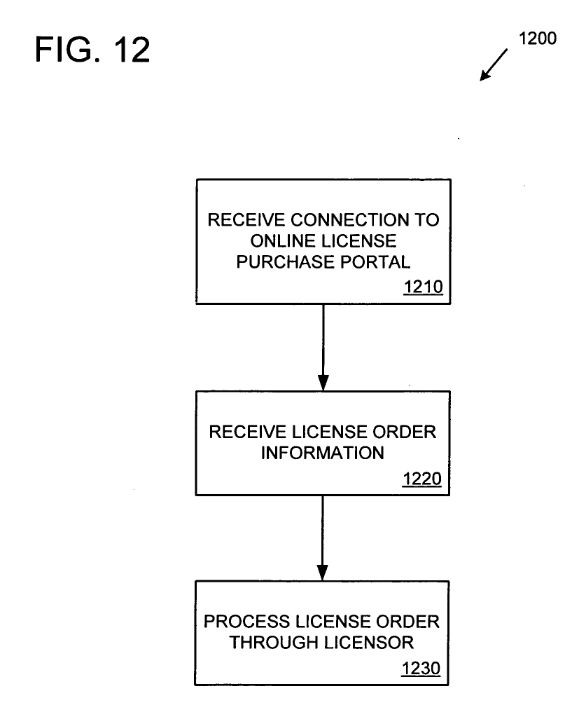

FIG. 12 shows an exemplary method 1200 for purchasing a license through a licensor. The method can be performed, for example, by a system such as that shown in FIG. 11. At 1210, a connection is received to an online license purchase portal. For example, the online license purchase portal can be a web site on the Internet. At 1220, license order information is received from the customer. At 1230, the license order is processed through the licensor.

### EXAMPLE 22

### Exemplary Storage of Purchased License

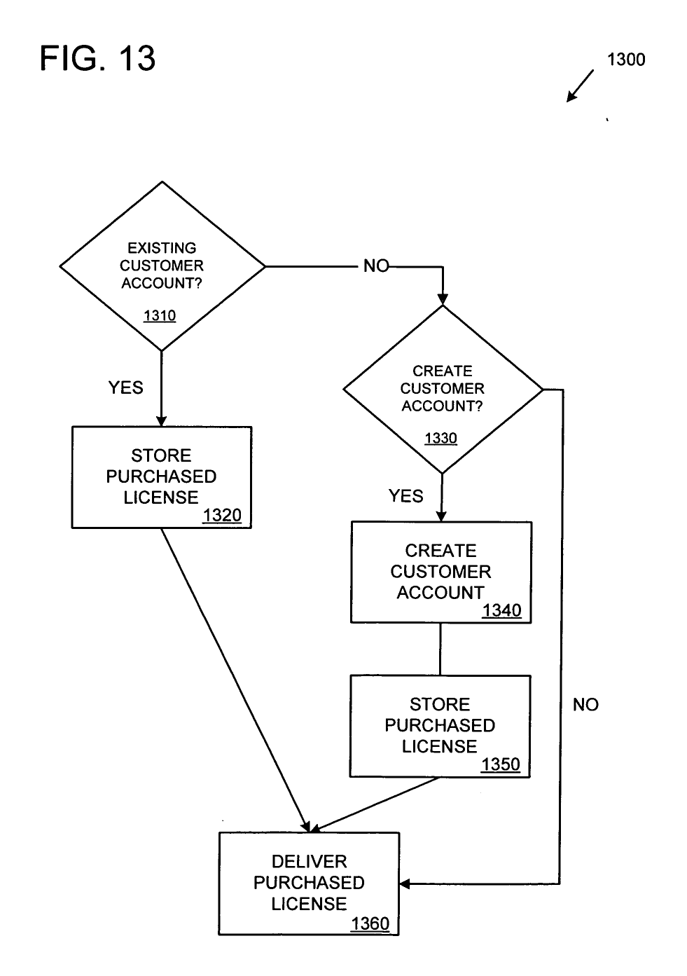

FIG. 13 shows an exemplary method 1300 for storing an electronic representation of a purchased license in a license storage account. The method can take place during a license purchase. For example, the method can take place during a license purchase using an online license purchase portal.

At 1310, if the customer has an existing license storage account (e.g., with the licensor providing the license), then the electronic representation of the purchased license is stored 1320 in the license storage account. After the electronic representation of the purchased license is stored, it is delivered 1360 to the customer.

If the customer does not have an existing license storage account, then the customer can be presented with an option to create a license storage account 1330. If the customer creates a license storage account 1340, then the electronic representation of the purchased license is stored 1350 in the license storage account and the electronic representation of the purchased license is delivered 1360 to the customer. If the customer decides not to create a license storage account, then the electronic representation of the purchased license is delivered 1360 to the customer without storing it in a license storage account.

### EXAMPLE 23

### Exemplary Computer Network

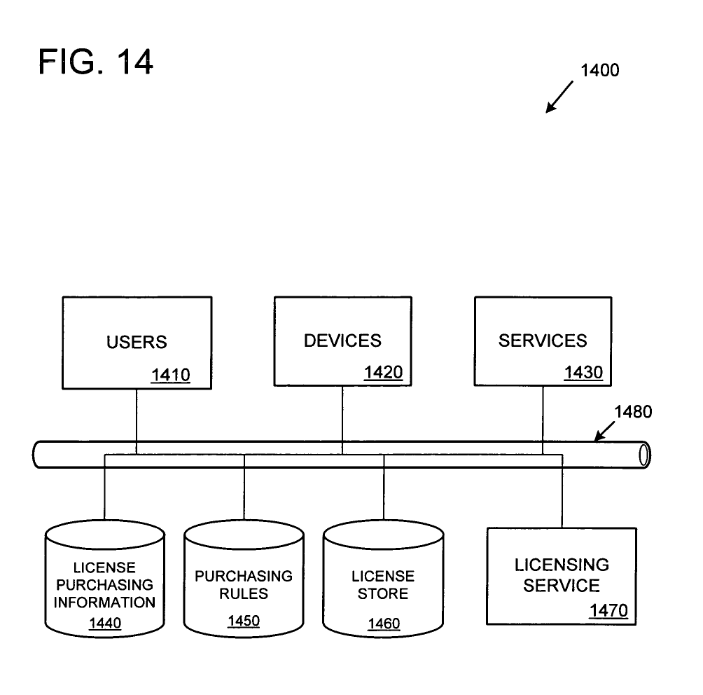

FIG. 14 shows an exemplary computer network 1400 supporting various aspects of licensing. The computer network can be a customer-controlled computer network. In the example, various items can be associated with the computer network.

Users 1410 can be associated with the computer network. For example, users can be people who use the computer network (e.g., typical employee, IT administrator, purchasing manager) via a username or other authentication method.

Devices 1420 can also be associated with the computer network. For example, devices can be computers (e.g., an employee's desktop or laptop computer), servers (e.g., file servers, application servers), or any other type of device (e.g., firewall or gateway device, printer, copier, scanner, communications device).

Services 1430 can be associated with the computer network. For example, services can be services provided by computer software (e.g., email services, accounting system services, virus scanning services, spam filtering services, backup services). Services can be provided by software running on servers or other devices on the computer network.

The computer network can have a storage facility for license purchasing information 1440, which can take the form described in any of the examples herein (e.g., example 8).

The computer network can have a storage facility for license purchasing rules 1450. The license purchasing rules can control the purchasing of licenses for the computer network. The license purchasing rules can also be automated so that they are checked automatically without user intervention (e.g., automatically checked periodically).

The computer network can have a license store 1460. The license store can store electronic representations of licenses for the computer network. For example, the licenses can be assigned to users 1410 or devices 1420 and allow them to access services 1430 on the computer network 1400.

A licensing service 1470 can be associated with the computer network. The licensing service can be a single service, or a number of services. Furthermore, the licensing service can run on a single machine (e.g., a server) or on multiple machines (e.g., multiple licensing services each running on a different machine, or a distributed licensing service).

A licensing service can perform many tasks. For example, a licensing service can participate in a license purchase. A licensing service can check licensing status on the computer network (e.g., how many licenses are in use or assigned to users or devices) and then evaluate license purchasing rules 1450 in order to make a license purchasing decision. A licensing service can purchase a license by connecting to an online license purchase portal (e.g., and use stored license purchasing information 1440 for the purchase). A licensing service can then download and install an electronic representation of a license (e.g., obtained from an online license purchase portal). The installation can comprise storing the electronic representation of the purchased license in a license store 1460.

A licensing service can also control other aspects of licensing on the computer network. For example, a licensing service can enforce licensing on the computer network. A service 1430 can receive a connection from a user 1410 or device 1420 on the computer network and the service can check with a licensing service 1470 in order to determine whether the user or device is authorized to access the service. Access to unauthorized services can be denied.

The items in the computer network 1400 can be linked together via a network 1480. For example, the network 1480 can be physical network cabling, or a wireless network, or some combination thereof. Various items can be linked together via various network hardware, protocols, and topologies. For example, the network 1480 can be a local area network, a wide area network, or a distributed network.

### EXAMPLE 24

### Exemplary Receipt of License

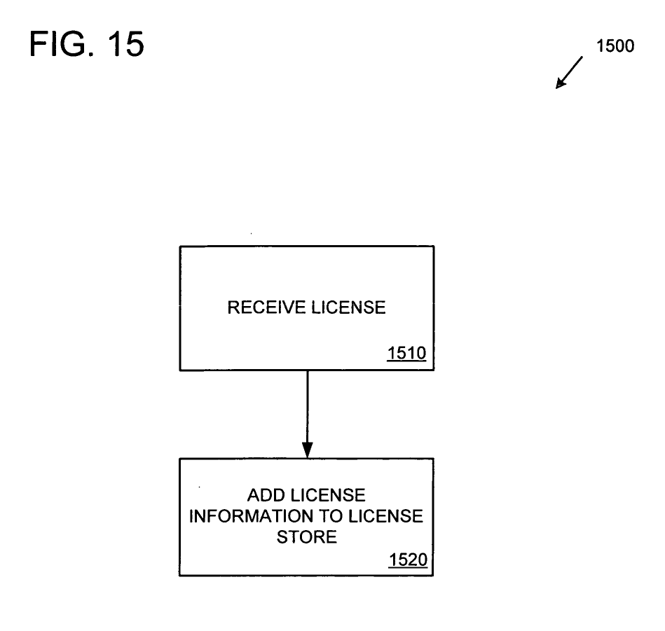

FIG. 15 shows an exemplary method 1500 for receipt of an electronic representation of a license. The method can take place during a license purchase. At 1510, an electronic representation of a license is received (e.g., from an online license purchase portal). The received electronic representation of a license can be in any number of formats. For example, the received electronic representation of a license can be in the format of a license code. It can also be in the format of a license serial number. The received electronic representation of a license can be in the format of a collection of information. For example, the collection of information can include various fields describing various aspects or terms of the license (e.g., license code, license type, date purchased, and version). The received electronic representation of a license can also be in the format of a secure unique license identifier (e.g., a string of alphanumeric characters) that can be used to uniquely associate the license with a specific customer or license purchase agreement. Such a secure unique license identifier can also be part of a collection of information comprising a license format, or part of a license schema (e.g., a field of the license schema).

At 1520, license information related to the electronic representation of the license is added to a license store. The license information can include the electronic representation of the license as it is received (e.g., a license code). The license information can also be information related to the electronic representation of the license as it is received. For example, if the electronic representation of the license is received as a collection of information, various fields of license information can be extracted from the collection (e.g., license code, license type, date purchased, version, and reseller) and stored separately or in combination in a license store.

### EXAMPLE 25

### Exemplary License Schema

In any of the examples described herein, a license can be received, as an electronic representation of the license, in a format described by a schema (i.e., a structure defining a collection of information) defined by a meta language. By using a license schema, a collection of information can be included in the electronic representation of the license. A license schema format can provide a number of benefits.

A license schema can provide various items of information about the license. For example, a license schema can define information about the license, such as: a license identifier, a license code, reseller information, version information, and date and time information. Such information could be used, for example, to verify or authenticate the license. Such information can also be used as a digital signature, which can be used to ensure the source and integrity of the license. For example, if a customer purchases a license and receives an electronic representation of the license in the format of a license schema, the customer can authenticate the license with the license seller (e.g., licensor, reseller) based on some or all of the information in the electronic representation of the license. In this way, the customer could be assured that the license is a valid license (e.g., not a forged or altered license).

A license schema can be parsed and the information within can be stored (e.g., in a license store) separately or in combination. Also, the various items of information in the electronic representation of the license can be stored automatically without the user having to manually enter the information.

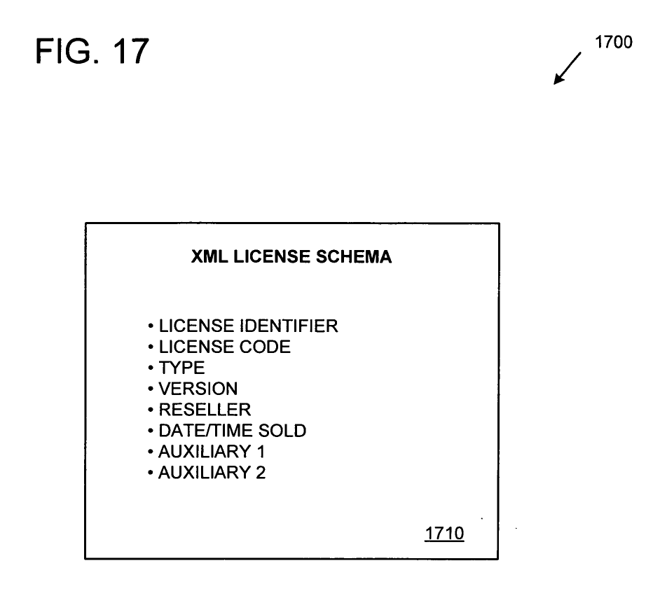

A license schema can be defined by various meta languages, such as XML or XrML. FIG. 17 shows an exemplary XML license schema 1700. In the example, the XML license schema 1710 comprises definitions for various fields of information, including: a license identifier, a license code, a type, a version, a reseller, data and time sold, and auxiliary fields. The auxiliary fields can be used for future expansion. Using an XML license schema can be advantageous because the XML schema standard is widely used and it allows an electronic representation of a license in the format of an XML schema to be distributed in a well defined and easily processed format.

### EXAMPLE 26

### Exemplary License Installation using XML Schema

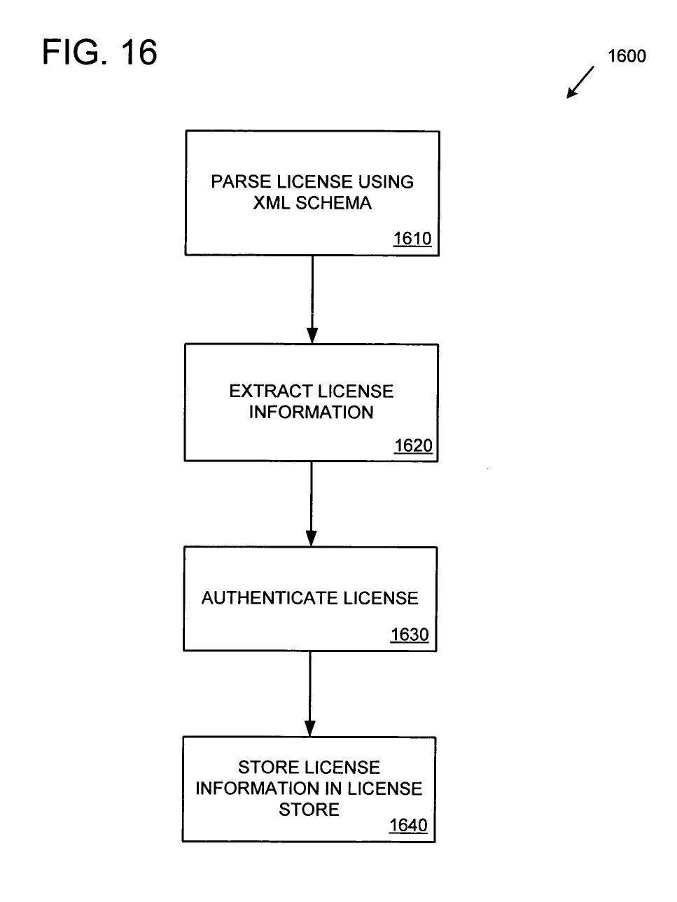

FIG. 16 shows an exemplary method 1600 for installing an electronic representation of a license using an XML schema. This method can take place after a license has been obtained (e.g., purchased from an online license purchase portal). The electronic representation of the license is in a format defined by an XML schema.

At 1610, the electronic representation of the license is parsed using the XML schema. Using the XML schema, the electronic representation of the license can be verified (e.g., that all of the fields within the electronic representation of the license conform to the XML schema), and the various fields of information can be identified.

At 1620, the various fields of information can be extracted from the electronic representation of the license. For example, the various fields of information can include: a license identifier, a license code, reseller information, version information, and date and time information. The parsing and extraction process can be performed by a computing device (e.g., by a licensing service running on a computer server) or manually.

At 1630, the license can be authenticated. For example, the license can be authenticated with a license seller (e.g., licensor or reseller) using the entire electronic representation of the license or one or more of the fields of information extracted from the electronic representation of the license. In this way, a fraudulent, forged, or invalid license can be identified.

At 1640, the electronic representation of the license can be stored in a license store. The entire electronic representation of the license, or individual fields (separately or in combination), can be stored in the license store. For example, the license store can be a database on a server.

### EXAMPLE 27

### Exemplary Dynamic License Pack

In any of the examples described herein, one or more licenses can be sold in a dynamic license pack. A dynamic license pack is an electronic representation of a license pack that can represent a variable (e.g., arbitrary) number of licenses. In contrast, a fixed license pack is a license pack that represents a fixed number of licenses (e.g., fixed by the license seller for general sale to customers). A dynamic license pack can be useful for a number of reasons.

For example, if a customer wants to purchase a specific number of license for which a license seller does not have a static license pack available, the customer can purchase a dynamic license pack. For example, if a customer wants to purchase a specific number of licenses (e.g., 17 licenses), and static license packs are only available in specific pre-set quantities (e.g., 5 and 25 pack licenses), then the customer would not be able to purchase the exact number of licenses needed using static license packs. However, using a dynamic license pack, the customer can purchase the specific number of licenses desired (e.g., 17 licenses).

A dynamic license pack has a license code that can be associated with a variable number of licenses. During the purchase of a dynamic license pack, the license code is associated with the specific number of licenses requested by the customer. For example, the license code can be associated with the specific number of licenses at a license reseller or at a licensor.

The electronic representation of the license can include a facility by which an arbitrary number of licenses can be indicated. Security measures (e.g., digital signatures, certificates, and the like) can be included to prevent altering the number of licenses.

In order to ensure that the correct number of licenses are installed by the customer, the dynamic license pack can be activated during installation. The activation process can include transmitting an activation request comprising the license code from the dynamic license pack to a clearing house. The clearing house activates the dynamic license pack by confirming the number of licenses associated with the license code and transmitting an activation response comprising activation information to the customer. Once the customer receives the activation response, installation of the dynamic license pack can be completed, and the number of licenses will be available for use.

The dynamic license pack can have its number of licenses set at the time of sale, or increased (e.g., by special offers) at a later date.

The clearing house can be operated by a reseller or by a licensor. The clearing house can be a web service or web portal on the Internet, for example.

### EXAMPLE 28

### Exemplary License Purchasing System for Dynamic License Packs

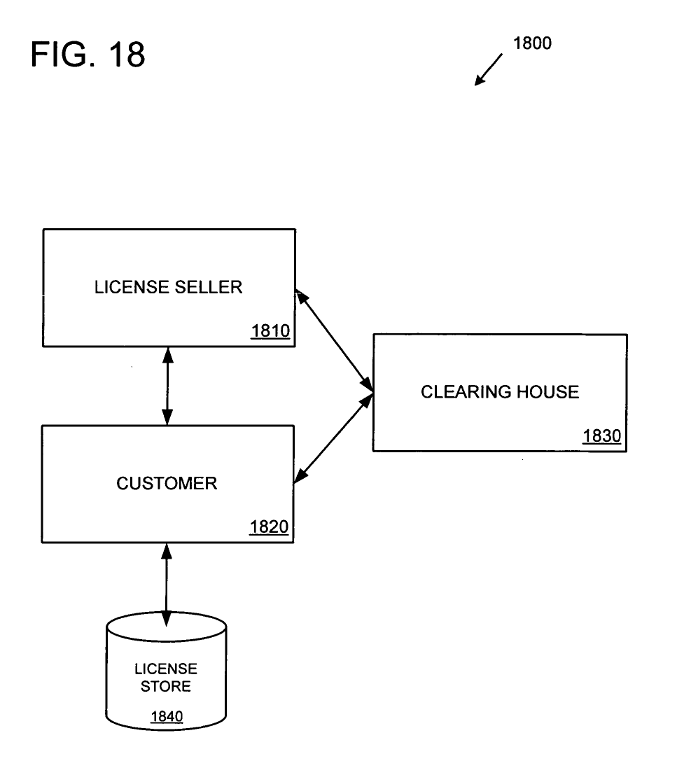

FIG. 18 shows an exemplary system 1800 for purchasing and activating a dynamic license pack. A dynamic license pack is an electronic representation of a license pack that can represent a variable number of licenses. In the example, a customer 1820 can purchase a dynamic license pack from a license seller 1810 (e.g., reseller, licensor). For example, the customer can make the purchase using an online license purchase portal. Once the customer receives the dynamic license pack, the dynamic license pack can be activated using a clearing house 1830. Using the clearing house can ensure that the correct number of licenses are activated. The activated licenses can be stored in a license store 1840.

### EXAMPLE 29

### Exemplary Purchasing and Activating a Dynamic License Pack

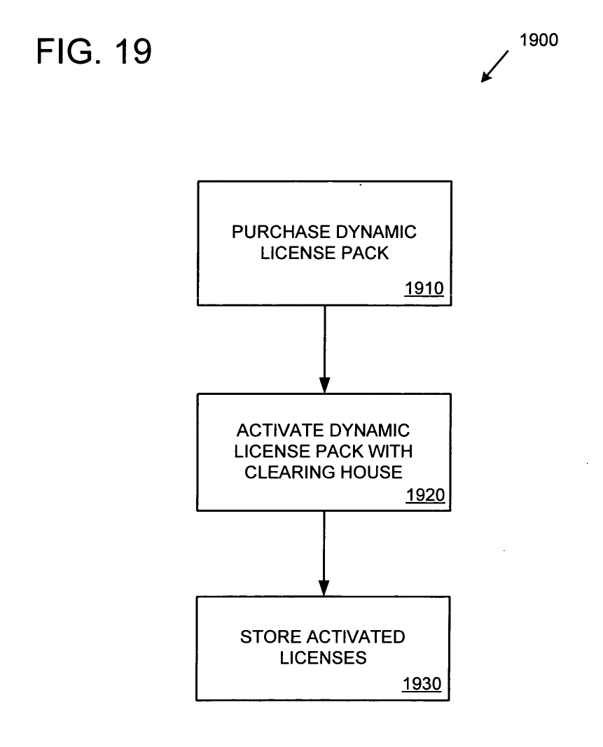

FIG. 19 shows an exemplary method 1900 for purchasing and activating a dynamic license pack. The method can be performed, for example, by a system such as that shown in FIG. 18. At 1910, a dynamic license pack is purchased by a customer. At 1920, the dynamic license pack is activated with a clearing house. Finally, at 1930, the electronic representations of the activated licenses are stored (e.g., in a license store) and are available for use by the customer.

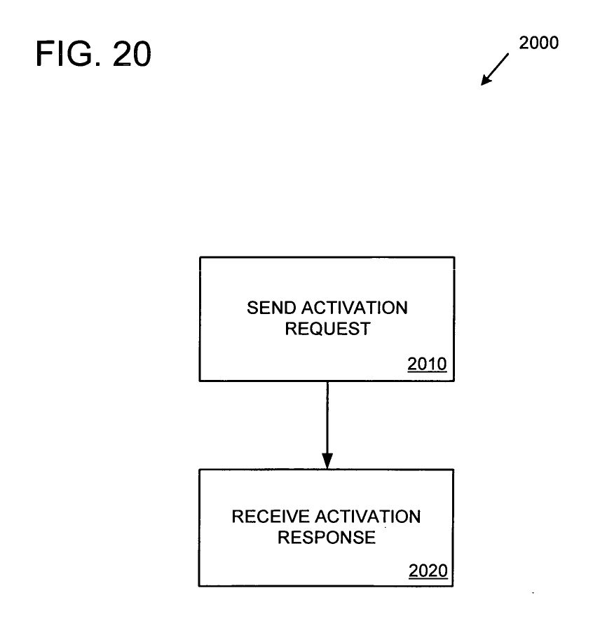

FIG. 20 shows an exemplary method 2000 for activating a dynamic license pack. The method can be performed, for example, by a system such as that shown in FIG. 18. After a dynamic license pack is received by a customer during a license purchase, an activation request is sent 2010. The activation request can comprise a license code from the dynamic license pack. For example, the activation request can be sent to a clearing house. The clearing house can be operated by a reseller or licensor, or by another entity. The clearing house can be accessible via a network (e.g., via the Internet). The activation request can be sent automatically (e.g., by a licensing service) during the license purchase and installation process.

At 2020, an activation response is received. The activation response is used to activate the specific number of licenses associated with the dynamic license pack. For example, the activation response can be received from a clearing house. The activation response contains information regarding the number of licenses to activate. The activation response can be received automatically (e.g., via a network such as the Internet) during the license purchase and installation process. The electronic representations of the activated licenses can be stored in a license store.

### EXAMPLE 30

### Exemplary License Purchasing Environment

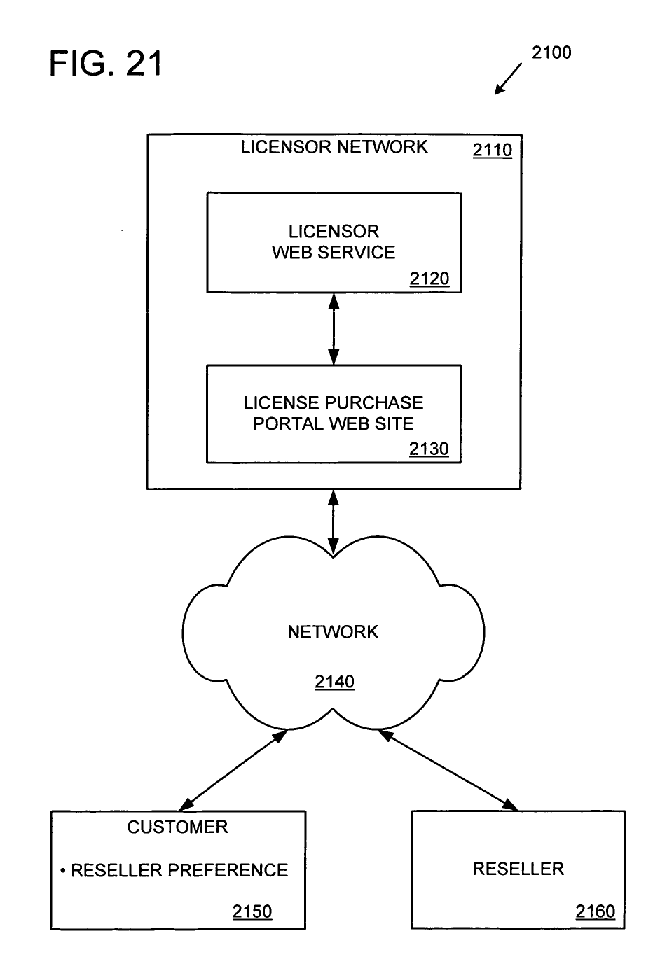

FIG. 21 shows an exemplary license purchasing environment 2100. In the example, a licensor network 2110 can provide licenses (e.g., as electronic representations of licenses). The licensor network comprises a licensor web service 2120 which can generate licenses (e.g., as electronic representations of licenses) and a license purchase portal web site 2130 which can accept license purchase connections. The licensor network can be connected to a network 2140 (e.g., the Internet) via the license purchase portal web site 2130.

A customer 2150 can purchase licenses, either directly from a licensor 2110 or from a reseller 2160. The customer can be connected to a network 2140, such as the Internet. The reseller 2160 can resell licenses from the licensor.

In the example, the customer can purchase a license from a reseller 2160 by connecting through a network 2140 to a license purchase portal web site 2130. At this point, the customer can purchase the license directly from the licensor, in which case the license purchase portal web site communicates with the licensor web service to retrieve the license (e.g., as an electronic representation of a license) and transmit the license back through the network to the customer.

The customer can also purchase the license through the reseller 2160. For example, the customer's computer can transmit, through the network, a reseller preference to the license purchase portal web site. The license purchase portal web site can use the reseller preference to identify a specific reseller through which to purchase the license. The reseller can be credited with the purchase, or the reseller can participate in the purchase process. For example, the customer can be redirected through the network to the reseller (e.g., a web site operated by the reseller), and the reseller can then retrieve the license (e.g., as an electronic representation of a license) from the license purchase portal web site (which in turn would retrieve the license from the licensor web service). The reseller can then transmit the license (e.g., as an electronic representation of a license) back through the network to the customer.

### EXAMPLE 31

### Exemplary Licensable Resources

In any of the examples described herein, licensable resources can be licensed to access computer services. For example, licensable resources can comprise users of a computer network, devices (e.g., computers such as laptops or desktops, printers, copiers, scanners, and other devices), services, or other types of entities (e.g., an business or organization). Licenses that can be used for any type of licensable resource, such that they are not limited to a specific type (e.g., assignable only to users), can be purchased.

Licenses can be assigned to specific types of licensable resources in order to make the most efficient use of available licenses. For example, if a licensable resource is a device (e.g., a laptop), and the device is used by more than one user, then a single license for accessing a service can be assigned to the device and the device can then support multiple users accessing the service from the device. As another example, if a licensable resource is a user, and the user frequently uses more than one device (e.g., a desktop at work and a laptop at home), then a single license for accessing a service can be assigned to the user and the user can then access the service from multiple devices.

In practice, the licensable resource for a user is the user's account (e.g., accessed via a username and password). Devices can similarly be associated with a device name.

### EXAMPLE 32

### Exemplary License Provisioning Rule

In any of the examples described herein, license provisioning rules can be used to control the provisioning of licenses. License provisioning rules can be automatic in operation. For example, a license provisioning rule can be created that automatically assigns an email service access license to each user licensable resource that is created (e.g., when the user name is assigned to a human user). Therefore, each time a user licensable resource is created, the license provisioning rule creates an assignment between an email service access license (if one is available) and the user licensable resource, allowing the user licensable resource to access the email service. The license provisioning rule can also assign an email service access license to each device licensable resource, thus allowing each device to access the email service (regardless of which user is using the device). In this way, for example, an IT administrator does not have to worry about manually assigning a number of licenses to newly created licensable resources. The IT administrator can simply create license provisioning rules once and the license assignments will take place automatically when the licensable resource is added. License provisioning rules can also operate when a licensable resource is edited or changed (e.g., disassociate a license when a licensable resource is removed).

License provisioning rules can create an explicit assignment between licenses and licensable resources. For example, a license provisioning rule can explicitly assign a specific license (e.g., using a unique license identifier associated with an electronic representation of the license) to a specific licensable resource (e.g., using a unique licensable resource identifier). In this way, it can be easily determined which licenses are assigned to which licensable resources. In addition, because license assignments are explicit, licensing can be more easily enforced. For example, only specific user licensable resources could be assigned a license to access an accounting service, and the accounting service could check the assignments to determine whether the user licensable resource requesting access is licensed.

License provisioning rules can also create an explicit assignment between multiple licenses (e.g., as a single group of licenses) and licensable resources. For example, a single unique license identifier can be associated with a group of licenses (e.g., a license pack), and the single unique license identifier can be assigned to a licensable resource (e.g., a user, device, business or organization, or service), or to a group of licensable resources.

Explicit license assignments can also support license compliance. For example, if a customer purchases a certain number of licenses (e.g., five) for accessing a service, those licenses can be explicitly assigned to specific licensable resources (e.g., to five specific users). In this way, a customer can know that they are compliant because only those specific licensable resources (e.g., the five specific users) will be able to access the service, and other licensable resources will be denied.

License provisioning rules can also create implicit assignments. For example, license provisioning rules can implicitly assign licenses to resources accessing a service up to a license pool limit (e.g., by decrementing a number of available licenses for each resource that is currently accessing the service).

### EXAMPLE 33

### Exemplary Computer Network for License Provisioning and Enforcement

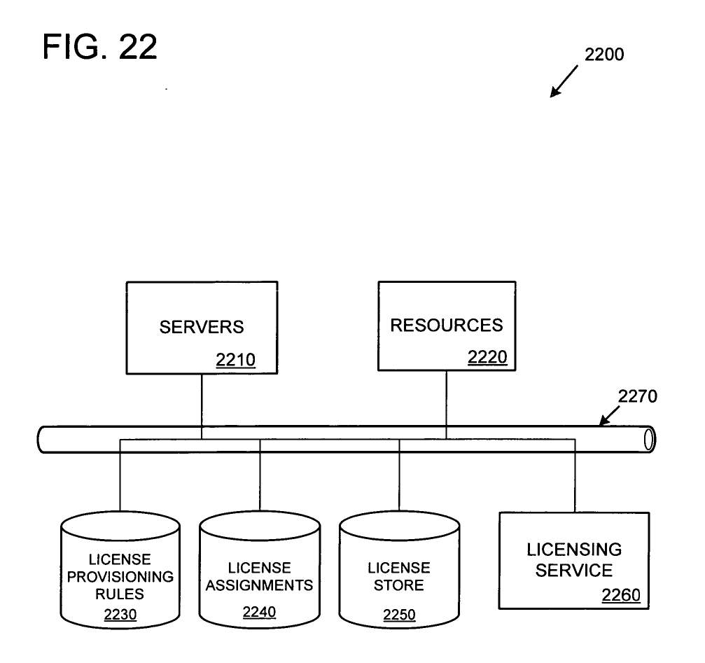

FIG. 22 shows an exemplary computer network 2200 supporting license provisioning and enforcement. In the example, various items can be associated with the computer network.

Servers 2210 can be associated with the computer network. The servers can be of a variety of types, for example: file server, email servers, gateway or firewall servers, backup servers, virus checking or spam filtering servers, and application servers.

Any of the licensable resources 2220 described herein can be associated with the computer network.

License provisioning rules 2230 can be associated with the computer network. License provisioning rules can control the provisioning of licenses on the computer network. License provisioning rules can be automatic in operation. For example, when a licensable resource 2220 is added to the computer network, one or more license provisioning rules 2230 can be checked. Based on checking the license provisioning rules, a license can be assigned to the licensable resource.

License provisioning rules 2230 can be stored, for example, in a database, registry, file, or the like.

The computer network can have a storage facility for license assignments 2240. License assignments can be assignments between licenses and licensable resources. License assignments can be stored in a database. License assignments can be stored (or edited) based on the operation of license provisioning rules or manually (e.g., by manual interaction by a user such as an IT administrator). For example, license assignments can be released (e.g., when a user leaves a company) and later reassigned.

The computer network can have a license store 2250. The license store can store electronic representations of the licenses for the computer network. For example, the licenses can be assigned to licensable resources 2220. The licenses can be associated with licensable resources in a license assignments database.

A licensing service 2260 can be associated with the computer network. The licensing service can be a single service, or a number of services. Furthermore, the licensing service can run on a single machine (e.g., a server) or on multiple machines (e.g., multiple licensing services each running on a different machine, or a distributed licensing service).

A licensing service can perform many tasks. For example, a licensing service can participate in automatically provisioning licenses. For example, when a licensable resource is added, the licensing service can check one or more license provisioning rules and based on the rules create assignments, in a license assignments database, between licenses, represented by an electronic representation of the licenses, in a license store and licensable resources. A licensing service can also participate in purchasing and installing licenses. A licensing service can check licensing status on the computer network (e.g., how many licenses are in use or assigned to licensable resources). A licensing service can purchase a license by connecting to an online license purchase portal. A licensing service can then download and install (e.g., store the electronic representation of the purchased license in a license store 2250) an electronic representation of a license (e.g., obtained from an online license purchase portal).

A licensing service can also control other aspects of licensing on the computer network. For example, a licensing service can enforce licensing on the computer network. A service can receive a connection from a licensable resource on the computer network and the service can check with a licensing service in order to determine whether the licensable resource is authorized to access the service. The licensing service can check with a license assignments database to determine whether the licensable resource is authorized to access the service. If it is determined that the licensable resource is not licensed (e.g., there is no license assignment in the database), access can be denied (e.g., by providing an indication to the service). A licensing service can also check licensing consistency on a computer network (e.g., by checking license or service assignments).

A licensing service can provide temporary licenses for use by resources (e.g., assigned to the resource) when no more licenses are available. For example, a licensing service can provide a temporary license in response to a service checking to see whether a resource attempting to connect should be allowed. The number of temporary licenses can be pre-set by an administrator. A temporary license can be automatically released (e.g., by a licensing service) when a license is purchased and installed, and the purchased and installed license can be automatically assigned to the resource that had the temporary license.

A licensing service can provide an API (application programming interface). For example, services can access an API of a licensing service to determine whether a licensable resource is authorized to access the service.

A licensing service can also manage dynamic license packs. For example, a licensing service can activate a dynamic license pack with a clearing house. Once activated, the licensing service can install the dynamic license pack (e.g., by installing one or more electronic representations of the dynamic license pack or by installing one or more electronic representations of individual licenses of the dynamic license pack). A licensing service can enforce a dynamic license pack by ensuring that the correct number of licenses represented by the dynamic license pack are activated, installed, and assigned.

The items in the computer network 2200 can be linked together via a network 2270. For example, the network can be physical network cabling, a wireless network, or some combination thereof. Various items can be linked together via various network hardware, protocols, and topologies. For example, the network can be a local area network, a wide area network, or a distributed network. The network 2200 can be a collection of local networks connected through a public network (e.g., the Internet) or a private network (e.g., leased lines).

### EXAMPLE 34

### Exemplary Creating a License Provisioning Rule

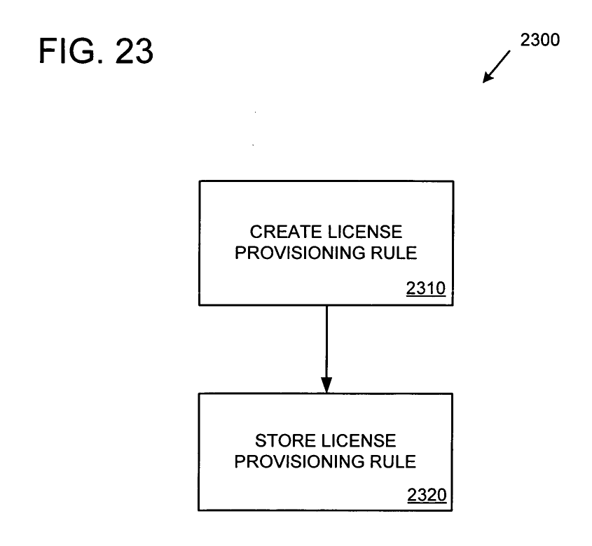

FIG. 23 shows an exemplary method 2300 for creating a license provisioning rule. The method can be performed, for example, by a system such as that shown in FIG. 22. At 2310, a license provisioning rule is created. The license provisioning rule can be an automated license provisioning rule. At 2320, the license provisioning rule is stored. The license provisioning rule can be stored in a license provisioning rules database. The license provisioning rule can also be stored in a registry, a file, or in another location. For example, license provisioning rules can be created by a user of a computer network (e.g., an IT administrator). The license provisioning rules can also be created in other ways (e.g., created when installing a software product, such as an email server software package).

### EXAMPLE 35

### Exemplary Automated License Assignment

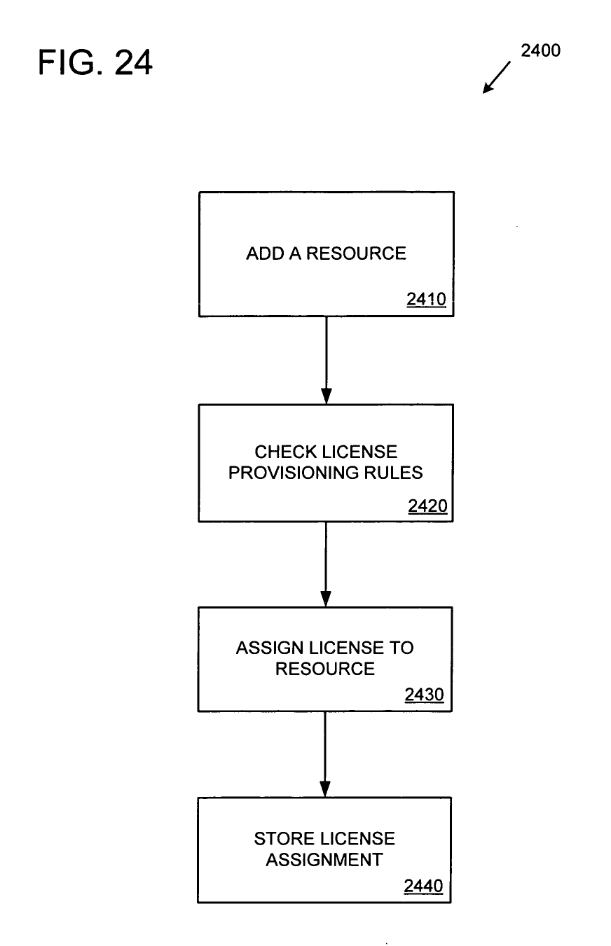

FIG. 24 shows an exemplary method 2400 for making automated license assignments. The method can be performed, for example, by a system such as that shown in FIG. 22. At 2410, a licensable resource is added (e.g., to a computer network). At 2420, one or more license provisioning rules are checked. At 2430, based on the license provisioning rules that were checked, a license is assigned to a licensable resource. At 2440, the license assignment between the license and the licensable resource is stored (e.g., in a license assignments database).

The license assignment can be automated because once the licensable resource has been added, the rest of the method can be automatic (performed by software such as a licensing service, without user intervention). For example, an IT administrator need only add a licensable resource, and the license provisioning (e.g., the assignment of multiple licenses to the licensable resource) takes place automatically. The IT administrator need not manually assign a number of licenses to the licensable resource.

### EXAMPLE 36

### Exemplary License Assignments

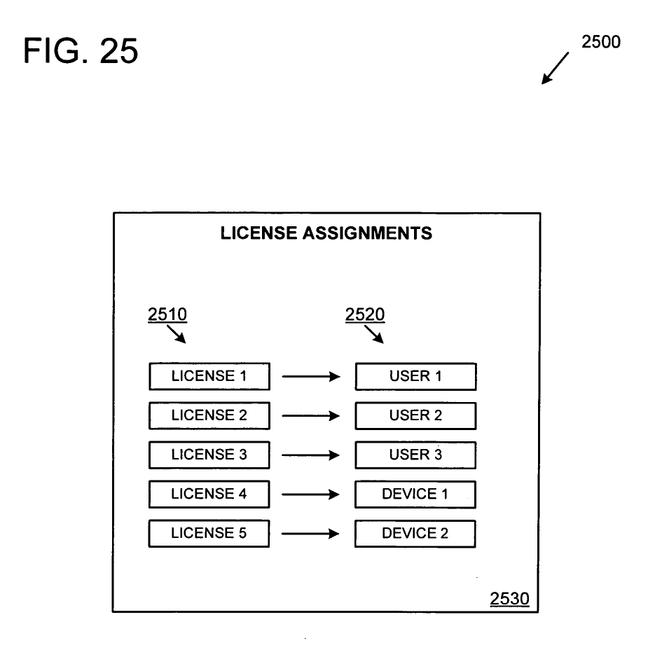

FIG. 25 shows an exemplary diagram 2500 of explicit license assignments. Explicit license assignments can be assignments between licenses and licensable resources (e.g., users and devices of a computer network). In the example, multiple licenses 2510 are explicitly assigned to licensable resources 2520. For example, “license 1” is assigned to “user 1,” and “license 4” is assigned to “device 1.” Licenses can be explicitly assigned by assigning a unique license identifier (e.g., representing a single individual license) associated with an electronic representation of the license to a unique licensable resource identifier (e.g., a single user or a single device). These explicit license assignments can be stored, for example, in a license assignments database.

### EXAMPLE 37

### Exemplary Automated Service Assignment

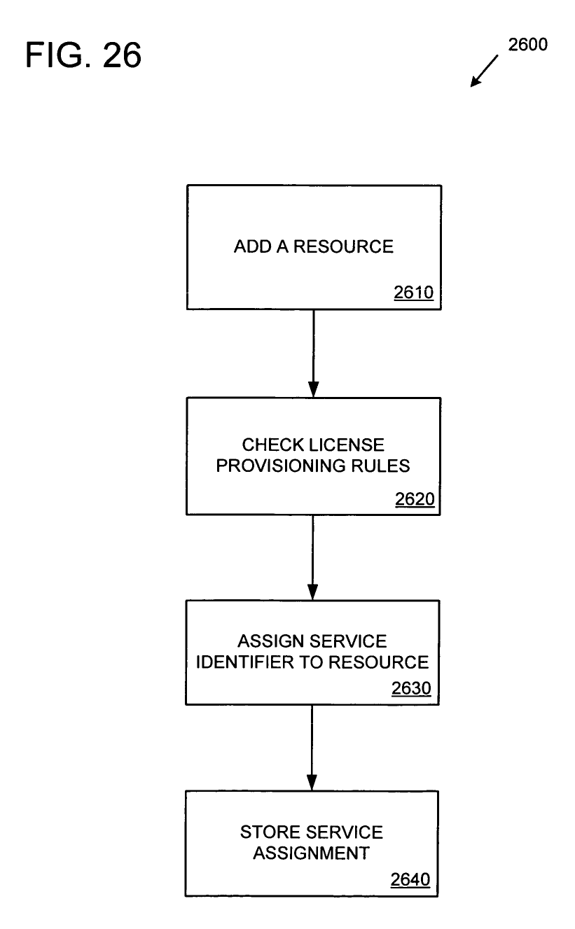

FIG. 26 shows an exemplary method 2600 for making automated service assignments. At 2610, a licensable resource is added (e.g., to a computer network). At 2620, one or more license provisioning rules are checked. At 2630, based on the license provisioning rules that were checked, a service identifier is assigned to a licensable resource. The service identifier can identify a specific service or a group of services. By assigning a service identifier to a licensable resource, services can allow access by licensable resources based on whether the licensable resource has been assigned a specific service identifier.

At 2640, the service assignment between the service and the licensable resource is stored (e.g., in a license assignments database). The service assignment can be stored in other locations as well, such as a licensable resource database (e.g., a user or device database) or in an active directory database.

The service assignment is automated because once the licensable resource has been added, the rest of the method can be automatic (performed by software such as a licensing service, without user intervention). For example, an IT administrator would only have to add a licensable resource and the provisioning would take place automatically. The IT administrator would not have to manually assign a number of service identifiers to the licensable resource.

### EXAMPLE 38

### Exemplary Service Assignments

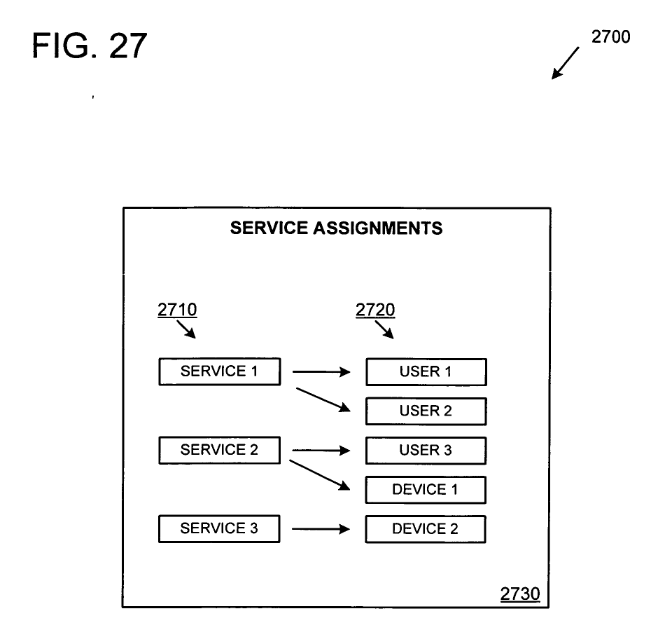

FIG. 27 shows an exemplary diagram 2700 of explicit service assignments. Explicit service assignments are assignments between service identifiers (representing a service or group of services) and licensable resources (e.g., users and devices of a computer network). In the example, multiple services 2710 are explicitly assigned to licensable resources 2720. For example, “service 1” is assigned to “user 1” and “user 2,” while “service 2” is assigned to “user 3” and “device 1.” As can be seen in the figure, a single service can be assigned to multiple licensable resources. Services can be explicitly assigned by assigning the unique service identifier to a unique licensable resource identifier (e.g., a single user or a single device). The service assignment can be stored (e.g., in a license assignments database, or other locations such as in an active directory database).

By making explicit service assignments, licensing can be enforced. For example, instead of, or in addition to, making license assignments, assignments can be made between services being licensed and licensable resources. By doing this, a service, for example, could merely check whether a licensable resource has been assigned a specific service identifier (e.g., meaning that the licensable resource has been licensed), which may be more efficient than checking license assignments.

### EXAMPLE 39

### Exemplary Realm

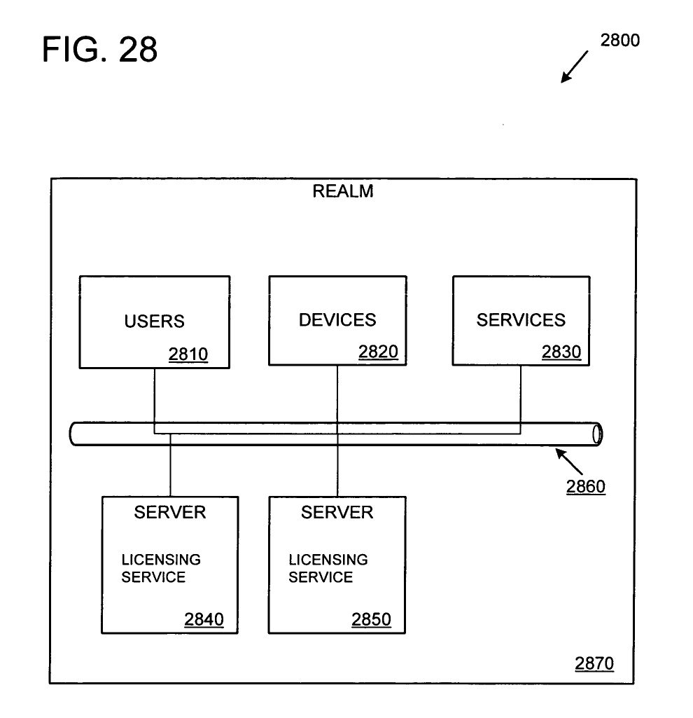

FIG. 28 shows an exemplary realm 2800 supporting various licensing activities. A realm 2870 can be the entire computer network of a business or organization. For example, a business may have a number of domains (e.g., each representing a different location, such as a city, in which the business has operations). All of the domains can be encompassed within the realm. In the example, various items can be associated with the realm.

Users 2810 can be associated with the realm. For example, users can be people who use the realm (e.g., typical employee, IT administrator, purchasing manager). Users may have access to the entire realm, to specific domains within the realm, or to other subdivisions of the realm.

Devices 2820 can also be associated with the realm. For example, devices can be computers (e.g., an employee's desktop or laptop computer), servers (e.g., file servers, application servers), or any other type of device (e.g., firewall or gateway device, printer, copier, scanner, communications device).

Services 2830 can be associated with the realm. For example, services can be services provided by computer software (e.g., email services, accounting system services, virus scanning services, spam filtering services, backup services). Services can be provided by software running on servers or other devices on the realm One or more servers providing licensing services (e.g., licensing servers) can be associated with the realm, such as 2840 and 2850. The licensing servers (and associated licensing services) can be organized into a hierarchy (e.g., a master licensing server and one or more peer or secondary licensing servers).

The items in the realm 2870 can be linked together via a network 2860. For example, the network 2860 can be physical network cabling, or it could be a wireless network. Various items could be linked together via various network hardware, protocols, and topologies. For example, the network 2860 can be a local area network, a wide area network, or a distributed network. The network 2860 can be a collection of local networks connected through a public network (e.g., the Internet) or a private network (e.g., leased lines). The network can cover a localized geographic area (e.g., a building) or a wide geographic area (e.g., multiple cities across several countries).

### EXAMPLE 40

### Exemplary License Enforcement

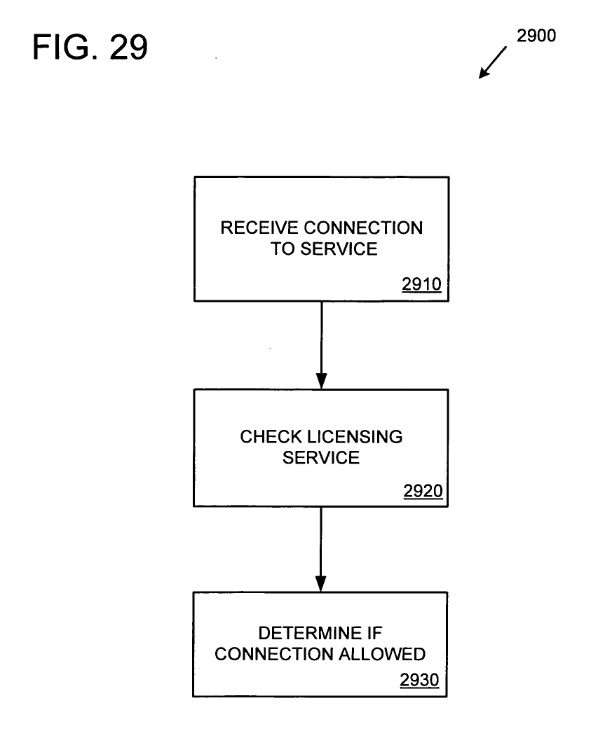

FIG. 29 shows an exemplary method 2900 for enforcing licensing. The method can be performed, for example, by a system such as that shown in FIG. 28. At 2910, a connection to a service is received. The connection can come from a user or a device for example. At 2920, a licensing service is contacted to determine if the connection should be allowed (if the licensable resource attempting to connect has an appropriate license). The licensing service can be a licensing service running on a licensing server of a computer network (e.g., a realm). The licensing service can be a master licensing service for example.

At 2930, a determination of whether to allow the connection is made. The determination is based on the result from the check of the licensing service 2920. For example, a user of a computer network can have a license to access an email service on an email server of the network. When the user attempts to connect to the email service, the email service can check a licensing service and determine that the user has an email service license and thus allow the connection.

License enforcement can also be accomplished in other ways. For example, resources can be tagged with a property (e.g., in a registry or directory) indicating that the resource is allowed to access a specific service. When attempting to connect to the specific service, the property can be checked to determine whether to allow the connection. For example, the property can be checked by a licensing service or by the service receiving the connection request.

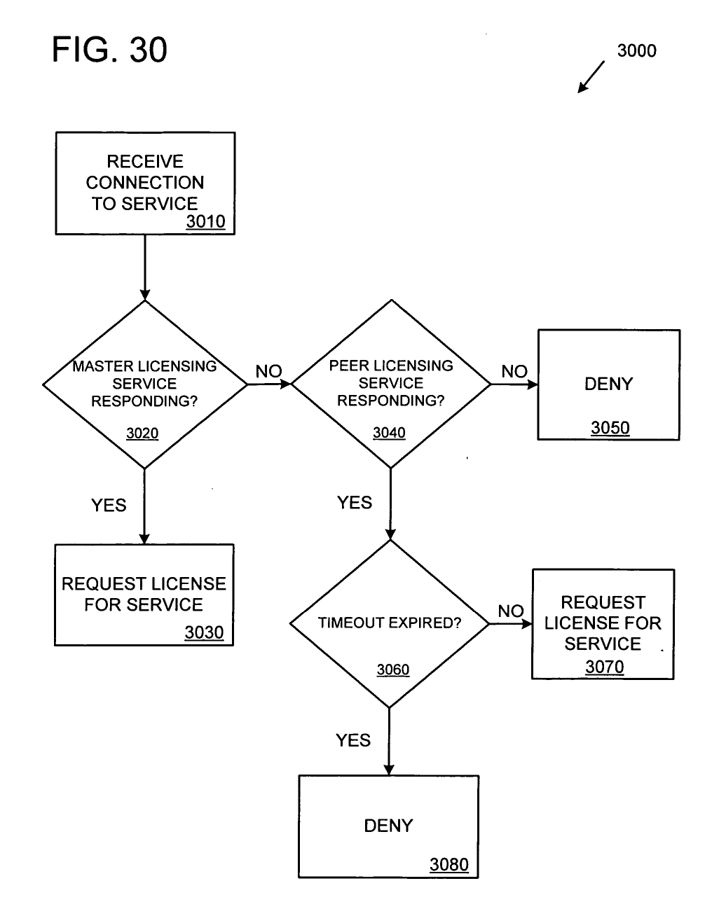

FIG. 30 shows an exemplary method 3000 for enforcing licensing in a multi-server environment. The method can be performed, for example, by a system such as that shown in FIG. 28. At 3010, a connection to a service is received. At 3020, a master licensing service (e.g., running on a master licensing service) is contacted to see if it is responding. Checking whether the master licensing service is responding may comprise checking one or more master licensing services (e.g., running on one or more master licensing servers). If the master licensing service is responding, then a license check can be requested 3030 from the master licensing service.

However, if the master licensing service is not responding, then a peer licensing service is checked 3040. In addition, if the master licensing service is not responding, warnings can be sent (e.g., to users). Checking whether the peer licensing service is responding may comprise checking one or more peer licensing services (e.g., running on one or more peer licensing servers). Even if the peer licensing service is responding, the connection may still be denied. When the master licensing service stops responding, a timeout can be set (e.g., a day, week, or other period of time). Before the timeout has expired 3060, licensing can be supported by the peer licensing service, and a license check can be requested from the peer licensing service 3070. But, if the timeout has expired, then licensing will be denied 3080 (e.g., the connection to the service will be denied). Similarly, if the peer licensing service also is not responding, licensing will be denied 3050.

Permitting licensing after the master licensing service stops responding allows licensable resources to continue using services while the master licensing service is restored. However, some licensing tasks may not be supported if a master licensing service stops responding. For example, license assignments (e.g., to resources) may not be supported by a peer licensing service.

### EXAMPLE 41

### Exemplary Warning of Licensing Problems

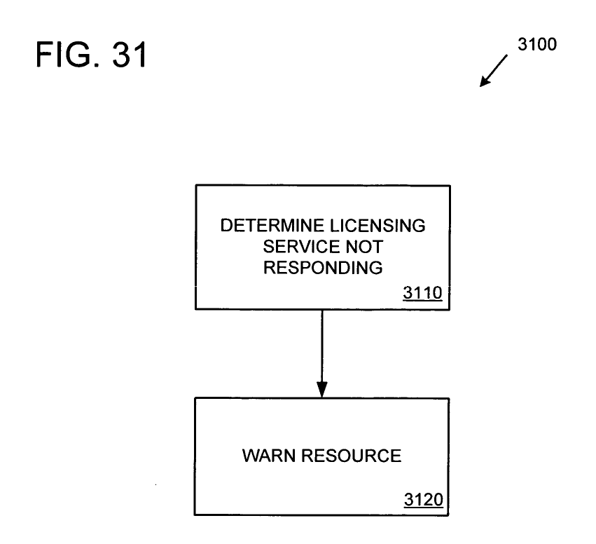

FIG. 31 shows an exemplary method 3100 for warning of licensing problems. The method can be performed, for example, by a system such as that shown in FIG. 28. At 3110, a determination is made that a licensing service is not responding. For example, a master licensing service may not be responding. Or, it may be the case that a peer licensing service is not responding. At 3120, a licensable resource is warned of the problem. For example, if a master licensing service stops responding, then a user associated with the licensable resource (e.g., a user of a computer network) can be warned of the problem. The warning can comprise information about the condition of licensing (e.g., on the network). For example, the warning can state that a master licensing service has stopped responding, but that licensing will be supported for a specific period of time (e.g., a day, week, or other period of time) by peer licensing services. The specific period of time can allow sufficient time to restore the master licensing service. As another example, the warning can state that licensing services will be suspended because a master licensing service has not responded for the specific period of time. The warning can take a variety of forms (e.g., a pop-up window, email message, page, or instant message).

### EXAMPLE 42

### Exemplary Enforcing License Requirements for Services

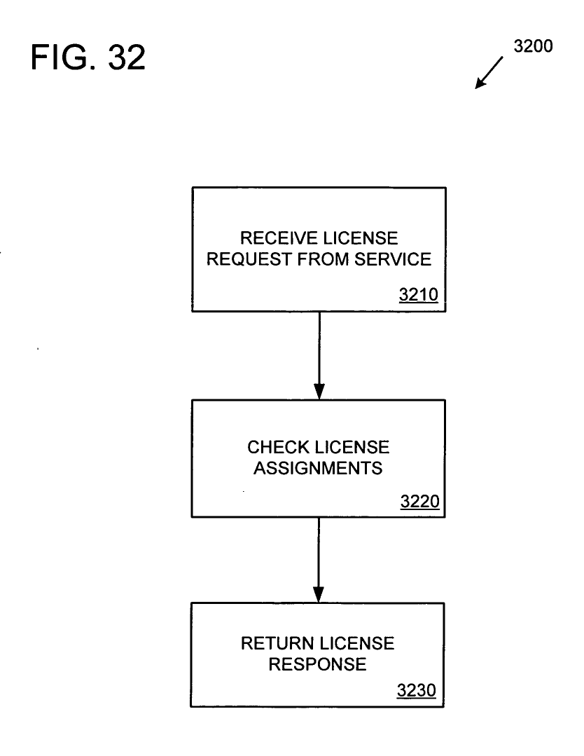

FIG. 32 shows an exemplary method 3200 for enforcing license requirements to connect to services using license assignments. At 3210, a license request is received (e.g., by a licensing service) from a service. At 3220, license assignments are checked (e.g., in a license assignments database that contains explicit license assignments between licensable resources and licenses). At 3230, a license response is returned to the service (e.g., from the licensing service). A license response can take a variety of forms. For example, a license response can contain a list of licenses associated with a licensable resource (e.g., a user licensable resource is licensed to access an email service and an accounting service). A license response can also state whether a specific license has been assigned (e.g., whether a user licensable resource has been assigned an email service license). A license response can also indicate that a licensable resource should be denied (e.g., the response can instruct the service to deny, or the service can deny based on the response).

License assignments can also be checked, and results stored or license responses sent, at different times. For example, license checks can happen when a resource is connecting to a service, as part of an integrated authorization process (e.g., when a user logs into a network), or at other times (e.g., as an automated audit process that occurs periodically).

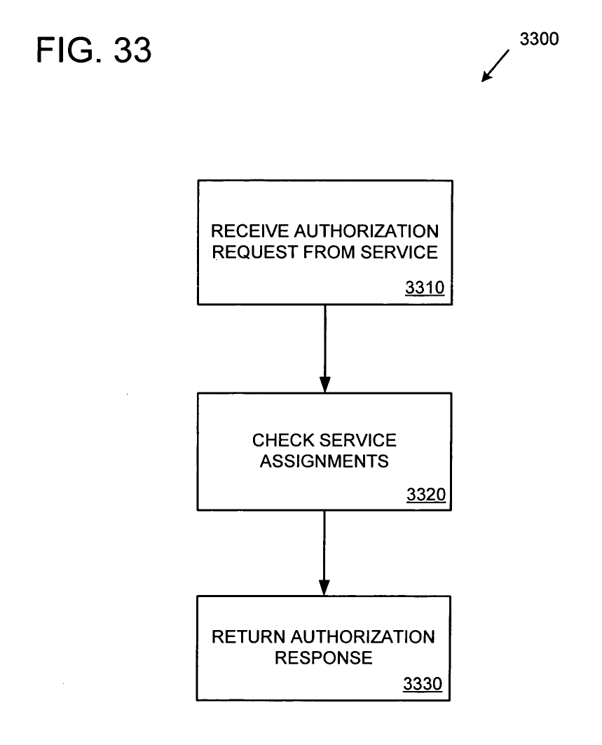

FIG. 33 shows an exemplary method 3300 for enforcing license requirements to connect to services using service assignments. At 3310, an authorization request is received (e.g., by a licensing service) from a service. At 3320, service assignments are checked (e.g., in a license assignments database that contains explicit service assignments between licensable resources and service identifiers). At 3330, an authorization response is returned to the service (e.g., from the licensing service). An authorization response can take a variety of forms. For example, an authorization response can contain a list of service identifiers assigned to a licensable resource. An authorization response can also state whether a licensable resource has been assigned a specific service identifier. An authorization response can also indicate that a licensable resource should be denied (e.g., the response can instruct the service to deny, or the service can deny based on the response).

### EXAMPLE 43

### Exemplary Promotion System

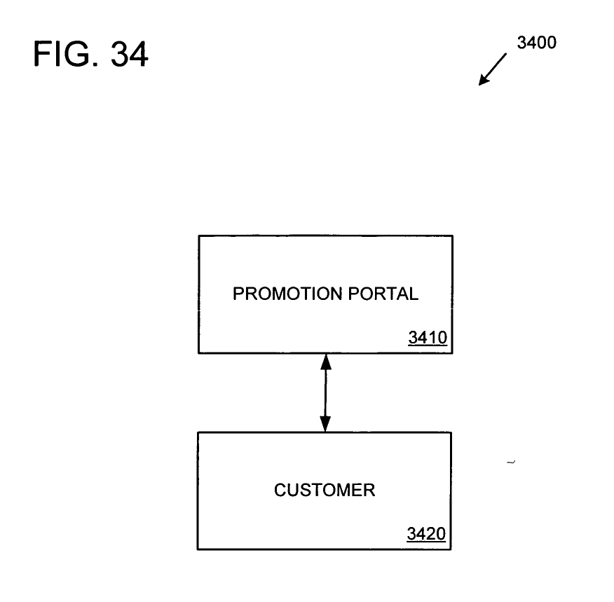

FIG. 34 shows an exemplary system 3400 for authenticating promotions. A promotion can be a software promotion provided by a software seller and used to offer a customer of the software seller a new or updated software product. The promotion can be based on previous software purchases by the customer. For example, the customer may have purchased a premium version of a software package from the seller in the past, and the seller now wishes to offer a new or updated program for use with the software package at no charge to the customer. The seller may want to ensure that only those who purchased the premium version of the software package are able to obtain the promotion software.

In the example, a customer 3420 contacts a promotion portal 3410 in order to obtain the promotion. The promotion portal can be a web site or web portal on the Internet. The customer can provide a promotion code based on a license code of installed software to the promotion portal in order to confirm that the customer owns the software in question.

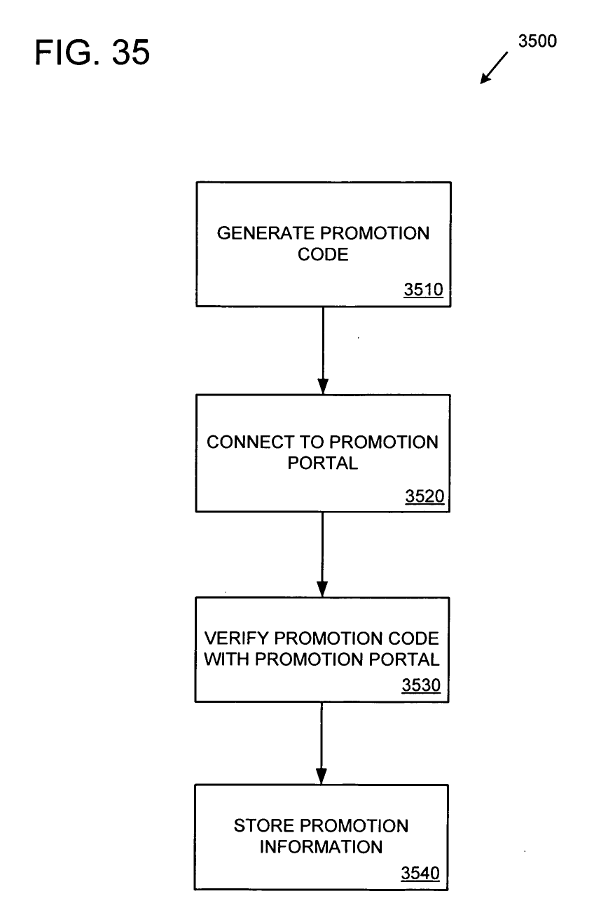

FIG. 35 shows an exemplary method 3500 for authenticating promotions. The method can be performed, for example, by a system such as that shown in FIG. 34. At 3510, a promotion code is generated. The promotion code can be a unique code based on software installed on a customer's computer system or network, or based on other attributes of the customer. At 3520, a connection to a promotion portal (e.g., a web site or service on the Internet) is made. At 3530, the promotion code is verified with the promotion portal. The verification process can comprise analyzing the promotion code to determine that the customer providing the promotion code has in fact purchased the software in question. The verification process can also comprise storing the promotion code so that the same customer (or another party) cannot use the same promotion (based on the same software in question) a second time.

At 3540, the promotion information is stored by the customer. The promotion information can comprise information allowing the customer to download promotion software (e.g., from the promotion portal). The promotion information can also comprise information unlocking a new feature of the software already installed.

### EXAMPLE 44

### Exemplary Computing Environment

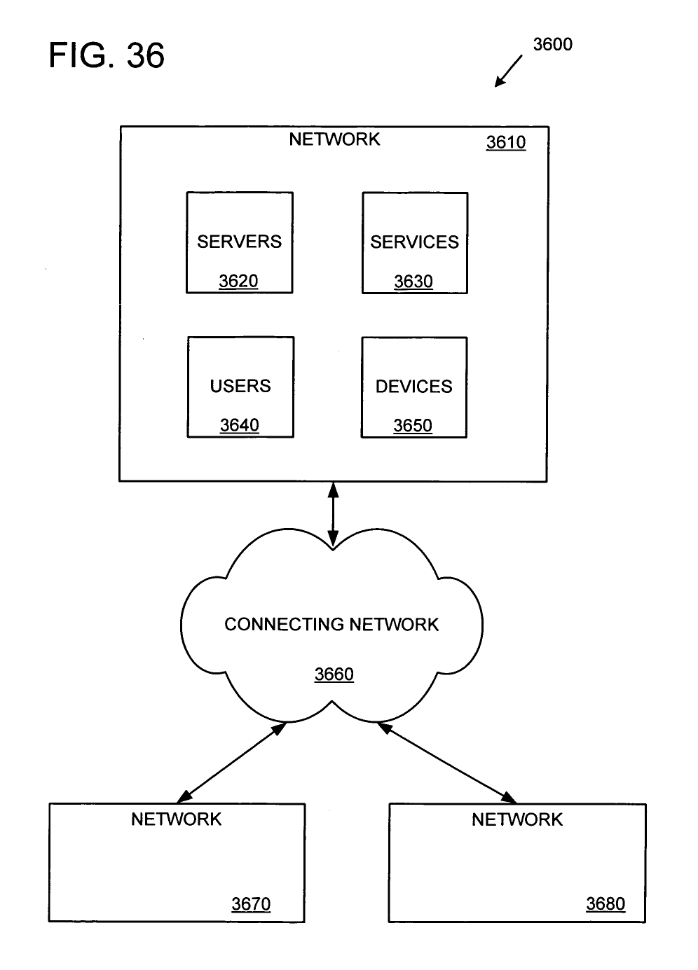

FIG. 36 illustrates an example computing environment 3600 that can be used to implement any of the technologies described herein. The computing environment includes a network 3610. The network 3610 can comprise servers 3620 (e.g., computer servers), services 3630 (e.g., computer services), users 3640 (e.g., general computer users, IT administrators, employees), and devices 3650 (e.g., desktop or laptop computers, printers, copiers, scanners).

The network 3610 can connect to other networks, such as 3670 and 3680 through in connecting network 3660. For example, the connecting network 3660 can comprise a wide area network such as the Internet or a local network. The connecting network can comprise various network hardware, protocols, and topologies.

### EXAMPLE 45

### Exemplary General Purpose Computer System

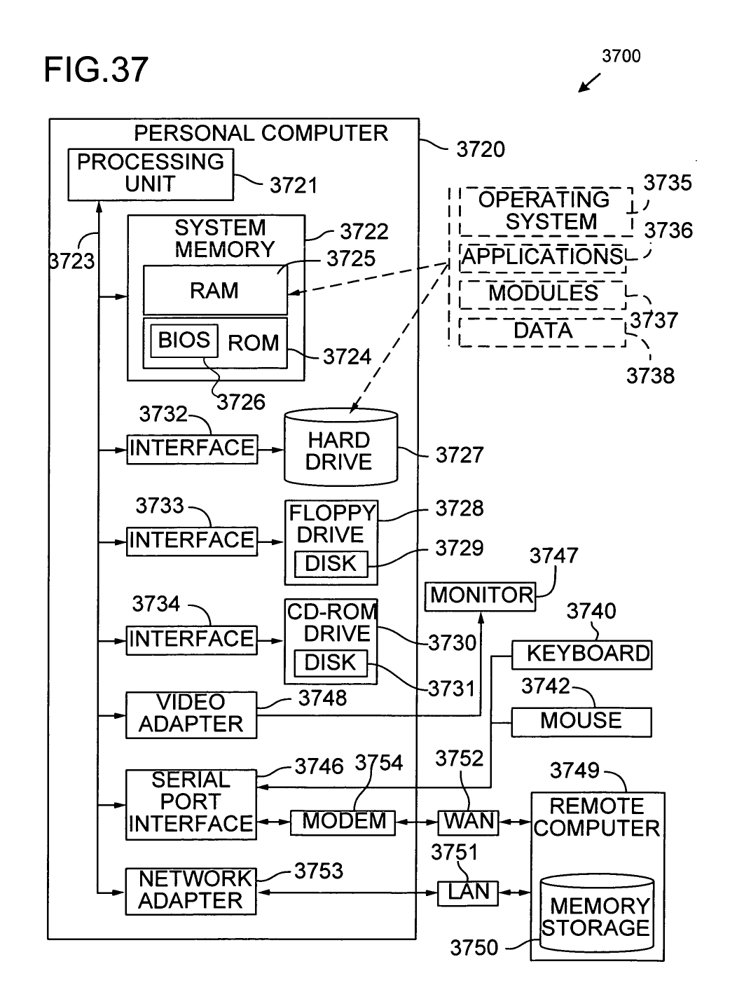

FIG. 37 illustrates an example of a computer system 3700 that can be used to implement any of the technologies described herein. The computer system includes a personal computer 3720, including a processing unit 3721, a system memory 3722, and a system bus 3727 that interconnects various system components including the system memory to the processing unit 3721. The system bus may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 3724 and random access memory (RAM) 3725. A basic input/output system 3726 (BIOS), containing the basic routines that help to transfer information between elements within the personal computer 3720, such as during start-up, is stored in ROM 3724. The personal computer 3720 further includes a hard disk drive 3727, a magnetic disk drive 3728, e.g., to read from or write to a removable disk 3729, and an optical disk drive 3770, e.g., for reading a CD-ROM disk 3771 or to read from or write to other optical media. The hard disk drive 3727, magnetic disk drive 3728, and optical disk drive 3770 are connected to the system bus 3727 by a hard disk drive interface 3772, a magnetic disk drive interface 3777, and an optical drive interface 3774, respectively. The drives and their associated computer-readable media provide nonvolatile storage of data, data structures, computer-executable instructions (program code such as dynamic link libraries, and executable files), etc. for the personal computer 3720. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 3725, including an operating system 3775, one or more application programs 3776, other program modules 3777, and program data 3778. A user may enter commands and information into the personal computer 3720 through a keyboard 3740 and pointing device, such as a mouse 3742. Other input devices (not shown) may include a microphone, joystick, game pad, satellite dish, scanner, or the like. These and other input devices are often connected to the processing unit 3721 through a serial port interface 3749 that is coupled to the system bus, but may be connected by other interfaces, such as a parallel port, game port or a universal serial bus (USB). A monitor 3747 or other type of display device is also connected to the system bus 3727 via an interface, such as a display controller or video adapter 3748. In addition to the monitor, personal computers typically include other peripheral output devices (not shown), such as speakers and printers.

The personal computer 3720 may operate in a networked environment using logical connections to one or more remote computers, such as a remote computer 3749. The remote computer 3749 may be a server, a router, a peer device or other common network node, and typically includes many or all of the elements described relative to the personal computer 3720, although only a memory storage device 3750 has been illustrated in FIG. 37. The logical connections depicted in FIG. 37 include a local area network (LAN) 3751 and a wide area network (WAN) 3752. Such networking environments are commonplace in offices, enterprise-wide computer networks, intranets and the Internet.

When used in a LAN networking environment, the personal computer 3720 is connected to the local network 3751 through a network interface or adapter 3757. When used in a WAN networking environment, the personal computer 3720 typically includes a modem 3754 or other means for establishing communications over the wide area network 3752, such as the Internet. The modem 3754, which may be internal or external, is connected to the system bus 3727 via the serial port interface 3746. In a networked environment, program modules depicted relative to the personal computer 3720, or portions thereof, may be stored in the remote memory storage device. The network connections shown are merely examples and other means of establishing a communications link between the computers may be used.

### EXAMPLE 46

### Exemplary Automated Methods

Any of the methods described herein can be performed via one or more computer-readable media having computer-executable instructions for performing such methods. Operation can be fully automatic, semi-automatic, or involve manual intervention.

### EXAMPLE 47

### Exemplary Combinations

The technologies of any example described herein can be combined with the technologies of any one or more other examples described herein.

### EXAMPLE 48

### Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer implemented method for automated purchasing of licenses, the method comprising:
based on an evaluation of one or more license purchasing rules, initiating a license purchase;
purchasing a license at an online portal; and
automatically downloading and installing the purchased license.

2. The method of claim 1 wherein at least one of the one or more license purchasing rules indicates that additional licenses are to be purchased when remaining free licenses drop below a user-configurable threshold.

3. The method of claim 2 wherein at least one of the one or more license purchasing rules indicates that no more additional licenses are to be purchased when a user-configurable number of additional licenses have been purchased, based on the evaluation of the at least one license purchasing rule indicating that additional licenses are to be purchased, over a user-configurable span of time.

4. The method of claim 1 further comprising:
storing license purchasing information prior to initiating the license purchase;
wherein purchasing the license comprises using the stored license purchasing information for the automated purchase.

5. The method of claim 1 further comprising:
determining whether approval is required to make the license purchase;
if approval is required, submitting a purchase approval request; and
based on a result of the purchase approval request, initiating the license purchase.

6. The method of claim 1 wherein initiating the license purchase comprises:
displaying an alert to a user requesting authorization to purchase the license; and
based on a response of the user to the request for authorization, proceeding with purchasing the license.

7. The method of claim 1 wherein purchasing the license at the online portal comprises:
submitting a reseller preference to the online portal; and
purchasing the license through a reseller identified by the reseller preference.

8. The method of claim 1 wherein purchasing the license at the online portal comprises:
purchasing the license through a licensor, wherein the licensor provides the license.

9. The method of claim 1 wherein purchasing the license at the online portal comprises:
storing a copy of the license at a licensor in a license storage account, wherein the licensor provides the license, wherein the license storage account is associated with a customer, and wherein the customer purchased the license.

10. The method of claim 1 wherein purchasing the license at the online portal comprises:
if a customer has a license storage account at a licensor, storing a copy of the license in the license storage account, wherein the licensor provides the license, and wherein the customer purchased the license.

11. The method of claim 1 wherein the license is in a format described by a schema defined by a meta language, and wherein automatically downloading and installing the purchased license comprises:
parsing the license using the meta language schema;
extracting license information based on the parsing;
authenticating the license with the online portal based on at least some of the extracted license information; and
storing the license information in a license store.

12. The method of claim 1 wherein the license is a license controlling access to a service on a computer network.

13. A computer system for automated purchasing of licenses, the system comprising:
a license purchase portal operable to receive a license order from a customer and deliver a license based on the license order to the customer;
a licensor operable to generate the license based on the license order; and
a license storage system operable to store the license offsite from the customer in a customer accessible license storage account.

14. The system of claim 13 further comprising:
a license reseller site operable to process the license order received from the customer;
wherein the license purchase portal is further operable to receive a reseller preference from the customer and communicate the license order to the license reseller site, wherein the reseller preference identifies the license reseller site.

15. The system of claim 13 wherein the license purchase portal comprises a web site, wherein the licensor comprises a web service, and wherein the license storage system is provided by the licensor.

16. The system of claim 13 wherein the license is in a format described by a schema defined by a meta language.

17. A computer readable medium having encoded thereon a license in a format described by a schema defined by a meta language, wherein the schema comprises:
a unique license identifier field for uniquely identifying the license;
a license code field for validating the license during installation; and
a reseller field for identifying a reseller associated with purchasing the license.

18. The computer readable medium of claim 17 wherein the schema further comprises:
a version field for identifying a version of software associated with the license;
a date field for identifying a date and time when the license was sold; and
an auxiliary field for supporting future expansion of the schema.

19. The computer readable medium of claim 17 wherein the schema can be authenticated by validating one or more of the fields of the schema with a service provided by the licensor.

20. The computer readable medium of claim 17 wherein the meta language is selected from the group consisting of XML and XrML.
